(19) United States
(12) Patent Application Publication
(10) Pub. No.: US 2025/0200428 A1
(43) Pub. Date: Jun. 19, 2025

(54) CLUSTER-BASED FEW-SHOT SAMPLING TO SUPPORT DATA PROCESSING AND INFERENCES IN IMPERFECT LABELED DATA ENVIRONMENTS

(71) Applicant: Oracle International Corporation, Redwood Shores, CA (US)

(72) Inventor: Dongwook Jang, Algonquin, IL (US)

(73) Assignee: Oracle International Corporation, Redwood Shores, CA (US)

(21) Appl. No.: 18/542,344

(22) Filed: Dec. 15, 2023

(51) Int. Cl. G06N 20/00

(52) U.S. Cl. CPC G06N 20/00

(57) ABSTRACT

The system and methods for determining the representative samples from a large imperfectly labeled dataset to support data processing and inferences for machine-learning applications. The method includes accessing data samples that may be processed to generate embedded vectors along with a set of reference labels. For each label, clustering is performed to group at least some of the embedded vectors together into clusters based on the associated inherent patterns, followed by a refinement process to select relevant clusters from the clustered patterns. One or more embedded vectors from the selected clusters are passed to a statistical technique to generate representative embedded vectors for each label. The statistical technique is configured such that the weights of selected embedded vectors within each of the cluster are the same. These representative embedded vectors may be further fed into a machine-learning model to predict a label from the set of reference labels for a given prompt.

### BACKGROUND

Sophisticated machine-learning models typically require substantial data quantities for training to derive meaningful insights and to generalize effectively to unseen data. However, acquiring accurately labeled data for training of machine-learning models can be challenging. The real-world scenarios generally involve imperfectly labeled data across various domains, where data points may be inconsistent, mislabeled or ambiguously labeled. The machine-learning models struggle in dealing with such imperfectly labeled data environments that may lead to degradation of performance, incorrect decision-making and in critical applications, potential safety risks. To address imperfect labeling by annotating each data sample can be time-consuming and resource-intensive, especially when the dataset is large.

While underlying data patterns may indicate that particular input-variable combinations correspond to a particular label, such predictions can be thwarted when a size of an input space expands and/or when there is more noise in the label. Moreover, large datasets and noisy labels can lead to poor generalization of machine-learning models. The models can overfit to the training data, capturing noise instead of true patterns. Such models are misguided by the imperfect labels during the learning process, causing the model to generalize incorrectly to unseen data. Consequently, the performance of the model to new, real-world data may be significantly compromised. Some existing strategies attempt to classify various data sets using labels, but any given label may correspond to complex data representations that may be subject to multiple separated types of noise. When a given label is associated with a representation that is associated with a complex noise pattern, classification becomes error-prone. These imperfect labels pose a hurdle in training accurate, robust and reliable machine-learning models to make precise inferences.

### SUMMARY

In some embodiments, a computer-implemented method is provided to determine representative samples from a large set of imperfects labeled data to support data processing and inferences for machine-learning applications. The method includes accessing a set of data samples from an imperfect labeled data. The data samples may be processed by generating an embedded vector for each sample in the set of data samples. One or more marked labels assigned to these data samples from a set of referenced labels are retrieved. For each marked label, a subset of the set of data samples is identified. After identification, a clustering technique is performed within the subset of embedded vectors associated with each marked label. The clustering technique groups similar data points together into clusters based on the associated inherent patterns that helps in dealing with label noise and reduce the number of data points to be reviewed and annotated. The number of clusters for each marked label may be either a predefined number selected by a user after observing the patterns in embedded vectors or it may be selected deploying one or more techniques that statistically determine the number of clusters. Subsequently, a set of clusters are generated for each marked label resulting in assigning the embedded vectors of each of at least some data samples in the subset to a cluster.

The generated clusters are refined by providing to a user the data samples associated with the embedded vectors of the cluster within each marked label to inspect the correctness of the embedded vectors for each cluster. If an indication is received for at least one of the set of clusters that the data samples associated with the embedded vectors of the selected cluster belong is irrelevant, the cluster is dropped. For each cluster from the refined clusters, one or more embedded vectors close to an associated centroid may be selected. The representative embedded vectors for each marked label are generated by employing a statistical technique that uses these selected embedded vectors closer to the centroid of each cluster. The statistical technique is configured such that a representation of or weight of selected one or more embedded vectors of each of the at least some of the set of clusters is the same.

In some embodiments, a prompt is generated from a set of data that includes embedded vectors of unlabeled or labeled samples, which may or may not overlap with the data used for extraction of representative embedded vectors. A machine-learning model is deployed that is trained on representative embedded vectors and takes the prompt as input, alternatively, for fine-tuning, a tuning matrix may be used as input, where the representative embedded vectors may be used to initialize the tuning matrix. For the given prompt, the machine-learning model generates a prediction and a probability corresponding to a given marked label from the set of reference labels that can be based on a similarity metric. The similarity metric measures the similarity between the given prompt and the representative embedded vectors.

To further improve the prediction accuracy, a probability threshold for each marked label from the set of reference labels may be estimated by accessing samples from a nil dataset and a query dataset to. A sample from nil dataset refers to the set of samples that do not belong to the marked labels from the set of reference labels. The query data is generated corresponding to the reference labels using embedded vectors associated with the selected clusters of the set of clusters but not using the selected embedded vectors closer to the centroids, where the prompt now includes or is based on the data corresponding to the query data. This process is carried out to minimize the occurrence of false positives, where the system mistakenly identifies or classifies a negative sample (nil sample) as positive. For determining the probability threshold for each marked label, the probabilities are generated by a probabilistic model for each prompt from the set of query data and for each embedded vector of nil data. Signal-to-nil ratio (SNR) for each interval of probabilities is calculated and a probability with highest SNR is selected as a threshold for a given label. The signal refers to the sum of probabilities generated by the probabilistic model for each interval of probabilities when the probabilistic model predicts the prompts belonging to the given label. If the probability of a given prompt is below this probability threshold for the given label, the prompt is designated as nil.

In an aspect of the present disclosure, the data samples may be text strings (e.g., log messages, webpages, articles), and the embodiments of the present disclosure can be utilized for various natural language processing (NLP) tasks, including entity recognition, classification, summarization, and the like. The text data can be in the form of sentences, paragraphs, documents, webpages, or any text-based input. This text data can be preprocessed depending on the nature of the data and NLP task. In this setting, the text data can be converted into meaningful numerical representations using a pre-trained embedding model or custom embeddings trained on a specific domain data. Each text string is represented as a high-dimensional embedding vector. After preprocessing, a clustering algorithm is used to cluster the embedded vectors. The clustering groups similar text strings together based on the semantic similarity, effectively creating clusters of related text. The clusters can be provided to a human annotator for inspection that may discard any cluster if the text strings are found irrelevant with the given reference labels.

Within each cluster, one or more text strings or embeddings may be selected that are closest to the center of each cluster in terms of cosine similarity or another distance metric. The representative embedded vectors are generated by a statistical technique using the selected embedded vectors. In an aspect of the present disclosure, the statistical technique is configured to compute a weighted average of the selected embedded vectors within a cluster, where the weights are kept same. If needed, annotation or validation can be performed for the text strings corresponding to the selected embedded vectors to crosscheck the correctness or relevance. The choice of clustering, number of clusters and selection of embedded vectors after cluster refinement can be tailored to specific use case and data characteristics.

The representative embedded vectors are chosen to capture the essence of the data and can be used to enhance several NLP tasks. One or more machine-learning models can be trained using the representative embeddings to predict entity names (e.g., organizations, locations, objects of interest, people etc.) or keywords within an independent (unseen) labeled or unlabeled text data. The method includes identifying one or more entity names for querying and detecting a webpage or web documents associated with the identified entity names. This detection may involve searching the web, accessing a database of webpages or using other means to find relevant web content. For this setting, the entity names belong to the labels from the set of reference labels. The method may estimate the time to have been newly generated within a predefined absolute or relative time period by using embedded information in webpages (e.g., timestamps, meta data, last update etc.) and to be associated with one or more specific entities. Once a relevant webpage is identified, other data samples from the webpage are extracted based on the relevancy with the entity names.

The extracted samples may be used as a prompt to query a machine-learning model trained on the extracted representative embedded vectors, as described above, from a set of data samples labeled from the set of one or more entities associated with the set of reference labels. The prompt may have the same dataset as that of the dataset used for extraction of representative embedded vectors or distinct having a separate query dataset. To predict the association between data samples, entity names and reference labels, the machine-learning model generates a predicted probability of one or more subsequent data samples associated with the entity name being associated with a particular reference label. This predicted probability is related to the likelihood or confidence that one or more data samples from extracted webpage are associated with a specific entity name as being a particular reference label from the predefined set of reference labels. After generating probability, another data sample may be processed using a different machine-learning model. This processing results in another prediction or probability related to whether the other text string (possibly extracted from the same or a different webpage) corresponds to the given reference label. The results from both predictions are combined incorporating information from both predictions and/or probabilities generating a blended result.

The disclosed method addresses the data heterogeneity issues by identifying subgroups within the data, which can be treated differently during the cluster refining or annotation process. By deploying clustering, the number of data points are reduced for manual inspection and annotation instead of annotating the entire dataset. The extracted representative examples determined from the disclosed method, may be used to train initial models, where the model actively selects and requests annotations for the samples it finds uncertain from a large unlabeled or imperfectly labeled dataset. This iterative feedback can lead to better selection of representative examples and improved performance, thereby reducing the need for extensive manual annotation.

In some embodiments, a system is provided that includes one or more data processors and a non-transitory computer readable storage medium containing instruction which, when executed on the one or more data processors, cause the one or more data processors to perform part or all of one or more methods disclosed herein.

In some embodiments, a computer-program product tangibly embodied in a non-transitory machine-readable storage medium, including instructions configured to cause one or more data processors to perform part or all of one or more methods or processes disclosed herein.

In some embodiments, a system is provided that includes one or more means to perform part or all of one or more methods or processes disclosed herein.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention as claimed has been specifically disclosed by embodiments and optional features, modification and variation of the concepts herein disclosed may be resorted to by those skilled in the art, and that such modifications and variations are considered to be within the scope of this invention as defined by the appended claims.

### BRIEF DESCRIPTION OF THE DRAWINGS

The present disclosure is described in conjunction with the appended figures:

FIG. 1 is an illustrative block diagram of a computer-implemented method that may be utilized for determining representative examples from a large imperfectly labeled dataset, in accordance with an example implementation.

FIG. 2 illustrates generation of embedded vectors from a set of data samples using an embedding model in accordance with some embodiments of the disclosure.

FIG. 3 is an example illustration of clustering and cluster refining method of embedded vectors for each label from a set of reference labels.

FIG. 4 is a block diagram of determining representative embedded vectors from a statistical model to perform one or more aspects of the disclosure described herein.

FIG. 5 is an example illustration of the probability optimization process of FIG. 1 generating a probability threshold for each label from the set of reference labels.

FIG. 6 illustrates a method of determining representative embedded vectors from a set of data samples with different labels in accordance with some embodiments of the disclosure.

FIG. 7 illustrates an example method to obtain a final prediction(s) for a given prompt by using the representative embedded vectors extracted in the method of FIG. 1.

FIG. 8A illustrates an example of normalized probability distributions of embedded vectors for a given label in the set of reference labels versus nil label to visualize the probability threshold calculated in the method of FIG. 5.

FIG. 8B illustrates another example of normalized probability distributions of embedded vectors for another label in the set of reference labels versus nil label to visualize the probability threshold calculated in the method of FIG. 5.

FIG. 9 illustrates a simplified diagram of a distributed system for implementing the method of FIG. 1.

FIG. 10 illustrates a simplified block diagram of a cloud-based system environment in which various services of server of FIG. 9 may be offered as cloud services.

FIG. 11 illustrates an example architecture of a computing system that can implement at least one example of disclosed method.

FIG. 12 illustrates an example flow of determining representative embedded vectors from a set of data samples and finding a set of probability thresholds for the given labels in accordance with some embodiments of the present disclosure.

FIG. 13 illustrates an example flowchart of a computer-implemented method according to an example embodiment.

### DETAILED DESCRIPTION

In some embodiments, techniques are provided to use machine-learning techniques to characterize and/or process a noisy, large data set that may comprise of one or more input modalities (e.g., text, audio, image or a combination thereof). The noisy, large data set may be used to train a machine-learning model and/or underlying algorithms. The data set may be noisy in that some of the labels that correspond to individual data elements in the data set may be inaccurate.

A data element or a data sample that is included in a training data set and/or that is input for inference may include (for example) a text string (e.g., a query to a chatbot, to a search engine, for an auto-complete, etc.), an image (e.g., for recognition of objects, facial expression, food etc.), audio (e.g., a speech sample for speech or emotion recognition, music genre, sound analysis, etc.) or multimodality (e.g., textual inputs accompanied with images or audios for image captioning, audio tagging, etc.). The data elements can be further transformed into an embedded representation of the corresponding data element based on the format or domain to which the data elements belong.

For example, if the input data element is in textual format, the transformation may be performed based on tokenization that breaks down the text into tokens. These tokens can be sentences, words, subwords, or characters depending upon the level of required granularity, linguistic properties of the text, and nature of the task. The tokens are then converted into embedding vectors using embedding models capturing the nuance of text and enabling the data elements to be processed by machine-learning algorithms. For textual input, the embedding models such as Word2Vec, GloVe (global vectors for word) or FastText can be used that takes individual words and perform a mapping of each word to a fixed-size vectors such that semantically similar words are closer in vector space. When dealing with data in the form of phrases, sentences, paragraphs and documents, embedding models such as Doc2Vec or transformer models e.g., bi-directional encoder representations from transformers (BERT) can be used. Such transformer models provide contextual embeddings based on attention mechanisms that consider the contextual information of the words in a document (e.g., a word can have different meanings depending upon the context or surrounding words). Such processes of converting textual inputs into embedding vectors may involve pre-trained models trained on large corpora of textual inputs to capture semantic relationships between words, phrases and documents. When a text input is given, these pre-trained models generate corresponding embedding vectors, which can be used for further inference and/or training of various NLP tasks.

The embodiments of the present disclosure may be utilized for performing NLP tasks such that extracting representative samples from a large imperfectly labeled textual dataset (e.g., comprising document, sentences, questions etc.) and training a machine-learning model that predicts labels, (e.g., spam or not spam, sentiment label or topic), or alternatively, generates responses, identifying entities, or producing accurate and coherent summaries. Beside NLP tasks, the embodiments of the present disclosure may be helpful in providing business insights and data enrichment services for various businesses to identify new opportunities, monitor market trends, perform sales analytics, and make informed decisions.

When the input includes images as data samples, the system may utilize one or more machine learning techniques to extract relevant features or embedded vectors. Images with varying resolution and formats (e.g., JPEG, GIF, or PNG) can be supported by utilizing preprocessing techniques to generate embedded vectors. For example, images can be resized, down-sampled, up-sampled, normalized or transformed (e.g., flip, rotate, augment) to handle varying size of the images. Deep learning models, such as convolutional neural networks (CNN), encoder-decoders, or pre-trained models (e.g., ResNet, VGG, Inception) can be employed to obtain meaningful embeddings from the image data samples. These embeddings capture the semantic information within the images.

In some embodiments, data elements in the form of audio inputs can also be utilized for inference. The audio samples can be sampled to discrete values considering factors e.g., sampling rate, and bit depth, thereby representing embedded vectors. Alternatively, the audio samples can be preprocessed, for example, for enhancing audio quality and to remove noise from audio samples, different noise reduction techniques can be utilized. Audio features can be extracted by preprocessing raw audios (e.g., using MFCCs, spectrograms, or machine-learning based features) to transform audio features into embedded vectors. For speech audio samples, speech recognition techniques such as automatic speech recognition (ASR) that converts audio into text data or the techniques that perform transcription of the speech data may be utilized to convert speech samples into textual data for further processing. These various forms of inputs showcase the adaptability of the present disclosure to perform with imperfect labeled data using data formats for example, text, image, audio or a combination thereof representing multimodal input.

In scenarios, where the input data samples are multimodal, i.e., when textual inputs are accompanied with images or audios (e.g., part-of-speech tagging, image/video captioning), multimodal embedding techniques can be deployed. Joint embeddings or multimodal techniques, for example, vision-and-language pretraining (VILBERT), contrastive learning or unified vision-and-language pretraining (UNITER), combine visual and textual information to create joint embeddings. Similarly, other multimodalities e.g., audio-text or audio-image data samples can be combined using multimodal embedding methods for audio-visual or audio-text tasks using techniques such as early fusion, late fusion, joint or parallel embedding models. These embedding vectors can be utilized in various tasks, such as image/video retrieval, content-based recommendation, or multimodal understanding. The focus of these multimodal embedding techniques is to effectively capture multiple modalities represented in a joint semantic space.

It is worth noting that for generating embedded vectors for each data sample belonging to the above-mentioned domains, custom-trained networks (e.g., machine-learning models, CNN based on encoder-decoder networks or any other neural network capable of generating encoded representations to be processed by a machine-learning model) may also be used.

The present disclosure determines the representative samples from a large imperfectly labeled dataset that may further be used to support inference and/or subsequent processing, such as assigning a new input data set to a cluster and/or processing it accordingly. The system may access data samples and the respective reference labels from a data set. The data samples may be preprocessed to generate embedded vectors or encoded representations. For each label, clustering is performed to group at least some of the embedded vectors together into clusters based on the associated inherent patterns. The clusters are refined to select the related samples from the clustered patterns. If a cluster is found not belonging to a given label from the set of reference labels, the cluster is dropped. For each label, one or more embedded vectors from the selected clusters are passed to a statistical technique to generate representative embedded vectors. The statistical technique is configured such that the weight of selected embedded vectors within each of the cluster is the same. The generated representative embedded vectors may be provided to a machine-learning model to predict the label from the set of reference labels for a given prompt. The prediction of the machine-learning model deploying representative embedded vectors can further be improved by utilizing a nil dataset to find a probability threshold for each label, where nil dataset refers to the data samples that do not belong to the given marked labels from the set of reference labels. After the prediction, if the highest probability assigned to all known labels is below the probability threshold for a given label, the prompt is designated as nil.

As-mentioned above, the data samples may belong to any data format for example domains including text, audio, images or a combination thereof (multimodal). These data samples are preprocessed to obtain fixed-size encoded vectors of numbers (embedded vectors), for example, raw audio waveforms can be converted into time domain vectors (e.g., by sampling and quantization) or frequency domain representations (e.g., Mel-frequency cepstral coefficients (MFCC) or spectrograms, images can be processed by neural networks to extract features, words or sentences may be converted into vectors using methods e.g., GloVe, or more recently transformer architectures, making it easier for the computer-implemented methods to interpret. Further, clustering is performed as a part of the process of extracting representative embedded vectors associated with each label to deal with label noise and ambiguity by grouping similar examples, which may share common labeling issues. To choose an appropriate number of clusters for each label, there are several techniques (e.g., Elbow method, Silhouette score, Davies Bouldin index, gap statistics) that use mathematical or statistical criteria to find appropriate number of clusters. These techniques aim to find a balance between maximizing clustering separation and minimizing cluster size while considering domain-specific knowledge when available. Clustering may be performed using one or more clustering techniques such as K-means, DBSCAN, hierarchical clustering, Gaussian mixture models etc. The quality of the clusters may be assessed in a refinement process.

In accordance with an aspect of the present disclosure, cluster refining may be performed by human annotators after observing the clusters. The human annotators can manually review the cluster based on the factors such as data quality, uniqueness, diversity, and relevance to the given marked labels from the set of reference labels. Other methods of cluster refining may include deploying one or more automated or semi-automated techniques, using validation metrics (e.g., silhouette score) or external validation metrics (e.g., adjusted random index). During refinement, the clusters that do not correspond to any labels are dropped, if found.

For each label, one or more embeddings are selected within each cluster deploying method such as selecting embeddings that are closest to the center of the cluster in terms of cosine similarity or another distance metric. The other selection methods may include choosing the centroid vector of each cluster as representative embedded vector, randomly sampling a fixed number of embedded vectors from each cluster, using density-based criteria to select vectors focusing on areas with a high density of embedded vectors within the cluster. If needed, annotation or validation can be performed for the selected embedded vectors to crosscheck the correctness or relevance. After selecting embedded vectors, the associated data samples may be investigated for the relevance of the data samples to each label. These selected embedded vectors are used to generate representative embedded vectors by a statistical technique. In an aspect of the present disclosure, the statistical technique is configured to compute a weighted average of the selected embedded vectors within a cluster, where the weights are kept same. The generated representative embedded vectors for each label are used to train a machine-learning model to predict a prompt or a query vector to find the most probable label from the set of reference labels.

As an illustrative example, if the input data samples are considered as text strings (e.g., log messages, webpages, articles), the embodiments of the present disclosure can be utilized for various natural language processing (NLP) tasks, including entity recognition, classification, summarization etc. The text data can be in the form of sentences, paragraphs, documents, webpages or any text-based input. This text data can be preprocessed by tokenization, cleaning, and normalization depending on the nature of data and NLP task. In this setting, the text data can be converted into meaningful numerical representations using pre-trained embedding models such as Word2Vec, FastText, BERT embeddings, or custom embeddings trained on a specific domain data. Each text string is represented as a high-dimensional embedding vector. After preprocessing, a clustering algorithm (e.g., K-Means, DBSCAN, or hierarchical clustering) can be used to cluster the embedded vectors. The clustering groups similar text strings together based on the semantic similarity, effectively creating clusters of related text. The clusters can be provided to a human annotator for inspection that may discard any cluster if the text strings are found irrelevant with given reference labels.

Within each cluster, one or more text strings or embeddings can be selected deploying method such as selecting the text strings or embeddings that are closest to the center of the cluster in terms of cosine similarity or another distance metric. The representative embedded vectors are generated by a statistical technique, for example, by computing an average of the selected embedded vectors with equal weights within a cluster using the selected embedded vectors.

The representative embedded vectors are chosen to capture the essence of the data and can be used to enhance several NLP tasks. For example, the embodiments of the present disclosure providing representative embedded vectors may be used for training machine-learning models that performs information retrieval, content aggregation or data mining to provide users with updated and relevant information about specific entity names or topics of interest. The system may access identified entity names as being associated with reference labels and find corresponding webpages. The time information related to webpages may be calculated by estimating when the webpages were created and modified. The data samples relevant to entity names can be extracted from the found webpage using individually or in combination of web scraping (e.g., manual scraping, Selenium, Regex, XPath and CSS Selectors etc.) or web crawling techniques (e.g., Depth/Breadth First crawling, Crawl delay etc.) depending upon the complexity and nature of accessed websites.

One or more machine-learning models can be trained to recognize entities or keywords within the text data using the representative embeddings. As another example, text documents or log messages can be classified by training a machine-learning model into predefined categories or classes based on the representative embedded vectors. During training, the model learns to predict the labels based on the input features (representative embedded vectors). Representative samples enable accurate and diverse range of input data (e.g., entities, patterns, sequences, context etc.) thereby improving the ability to generalize to unseen data. Alternatively, the representative embeddings can be utilized to generate summaries or abstracts of longer text documents or leveraging the embeddings for content recommendation or similarity-based search. The disclosed technique helps in condensing large volumes of text data into meaningful and representative samples, which can improve the efficiency and accuracy of various NLP tasks in various text analysis applications.

As an alternative example, input data samples in the form of audios, images, videos that may be considered as sequence of images (or a combination thereof) can be converted into numerical representations (embeddings) through feature extraction methods. After generating encoded representations or embeddings, clustering algorithms including, but not limited to, K-Means, DBSCAN, hierarchical clustering may be applied to group similar patterns creating clusters of visually similar images. The clusters can be provided to a human annotator for inspection that may discard any cluster if the images or audios are found irrelevant according to given reference labels. Within each cluster, one or more embedded vectors are selected considering the corresponding images or audios. In an aspect of the present disclosure, the selection can be done by choosing the embeddings that are closest to the center of the cluster in terms of cosine similarity or another distance metric. The representative embedded vectors are generated by feeding these selected embedded vectors to a statistical technique that is configured to compute a weighted average of the selected embedded vectors within a cluster, where weights are kept same. For the image domain, the representative images can be utilized for various vision tasks such as content-based image retrieval, object recognition, or image classification. For the audio domain, the selected representative audio segments can be utilized for tasks such as audio classification, content-based audio retrieval, or speaker recognition. In both cases, the process involves converting data (images or audio) into representative embedded vectors, clustering similar data points, selecting representative samples, and leveraging these representations for training a machine-learning model to perform various tasks.

The choice of clustering algorithms, embedding models, and selection of number of clusters may vary depending on the specific application and data characteristics. Additionally, for machine-learning models to perform various tasks, a separate dataset may be used for querying a prompt comprising of unlabeled or labeled samples, which may or may not overlap with the data used for extraction of representative embedded vectors.

The representative embedded vectors are fed into a machine-learning model that generates a prediction or a response for a given prompt. The prompt can either belong to the same data set that is used to extract representative embedded vectors or it can be obtained from an independent source. The prompt can be fed into the same embedding model used for the representative embedded vectors to generate corresponding embedded vector. The embedded vector corresponding to the prompt is further given to the machine-learning model that is trained on the representative embedded vectors. There may be various types of machine-learning models, depending on the specific task and objectives. The machine-learning model may include supervised learning models (e.g., logistic regression, decision trees, random forest, neural networks or regression models such as linear regression, ridge regression, gradient boosting regressors when the target variable is continuous or numerical), unsupervised learning models (e.g., K-Means clustering, hierarchical clustering, dimensionality reduction models), semi-supervised learning models (e.g., self-training, label propagation, and co-training), transfer learning models utilizing pre-trained models on large datasets and fine-tuned with the representative examples, ensemble models combining multiple base models to improve predictive performance (e.g., bagging, boosting, stacking), time series models (e.g., ARIMA, LSTM) if the prompt exhibits temporal patterns such as for the case of audio inputs, reinforcement learning for tasks involving sequential decision-making (e.g., deep Q-networks, proximal policy optimization (PPO), NLP models or transformer-based architectures for text classification, and language generation. The extracted representative embedded vectors may also be used in a machine-learning model working as a recommendation system (e.g., for collaborative filtering, content-based filtering) and graph neural networks in tasks like node classification, link prediction, and community detection.

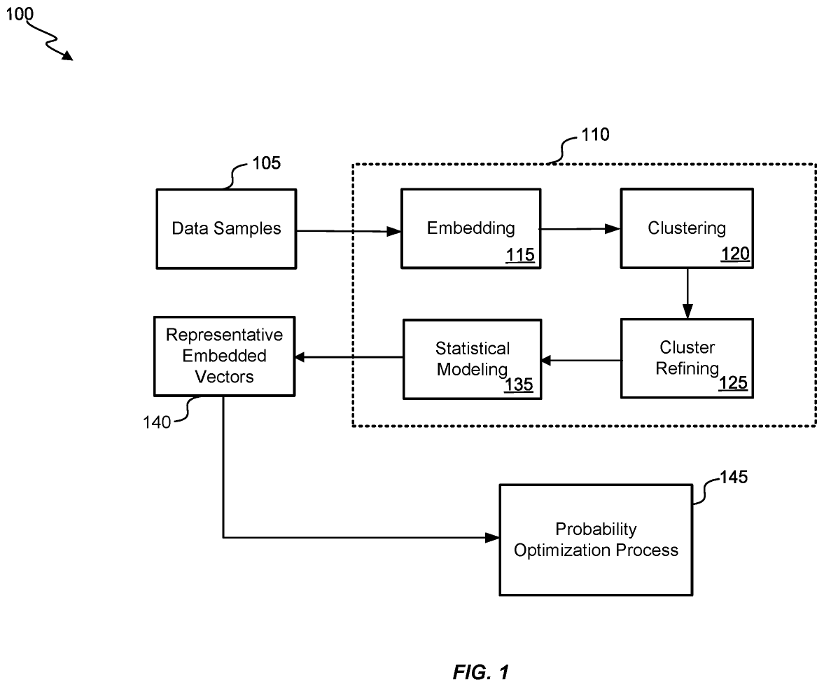

FIG. 1 is an illustrative block diagram of a computer-implemented method that may be utilized for determining the representative examples from a large imperfectly labeled dataset, in accordance with an example implementation. The computer-implemented method 100 takes a set of data samples 105, from imperfect labeled datasets, as an input. The data may include text data, audio data, video data, time-series data and/or image data. The data samples 105 can be stored in a data repository and/or a database present within a computing system or a data repository. The data samples 105 obtained are fed into a representative embedded vector generation module 110 that may comprise of various processes including embedding 115, clustering 120, cluster refining 125 and statistical modeling 135. The embedding model 115 can be deployed to process data samples 105 by generating an embedded vector for each sample in the set of data samples 105. The embedding model 115 converts each data sample from the set of data samples 105 into array of numbers called an embedded vector which is stored in an index within a vector database. The embedded vector may provide a numerical representation of the semantic meaning of a data sample 105 in a multi-dimensional space. The embedded vector can be generated using various embedding techniques and/or algorithms that may include Hot Encoding, SBERT, TF-IDF, Word2Vec, FastText etc. After obtaining embedded vector a set of reference labels is identified and for each data sample of the set of data samples 105, a marked label is obtained.

The output from the embedding model 115 is utilized for clustering 120. The marked labels assigned to the data samples 105 from a set of referenced labels are retrieved. For each marked label, a subset of the set of data samples 105 is identified and a number of clusters are designated to each marked label. After identification of the subset data samples 105, a clustering 120 technique is performed using the embedded vectors of the data samples 105 within the subset associated with each marked label. Herein, the term “clustering” refers to classification of data into cluster and/or groups based on similar characteristics and/or data patterns. Any clustering 120 technique (e.g., K-means clustering, adaptive k-means clustering, DBSCAN, agglomerative clustering, hierarchical clustering, Gaussian mixture models) can be deployed. A set of clusters are generated by choosing an appropriate number of clusters resulting in assigning the at least some embedded vectors of data samples 105 in the subset to a cluster within each marked label. The number of clusters for each marked label may either be a predefined number selected by a user after observing the patterns in embedded vectors or it may be selected dynamically deploying one or more techniques such as dynamic k-means clustering, incremental DBSCAN, incremental hierarchical clustering etc. that dynamically determine the number of clusters.

Following the clustering 120 process, cluster refining 125 is performed where a user is provided the data samples 105 associated with the embedded vectors for each marked label from the set of reference labels to inspect the correctness of embedded vectors for each cluster. The inspection may be performed manually by using a human annotator or through automated and/or semi-automated techniques. If any cluster is found irrelevant according to the set of reference labels, the cluster is dropped. Correspondingly, the number of clusters are updated. In an example, where cluster refining 125 is performed by a human annotator, the human annotators manually review the subset of data samples 105 based on the factors such as data quality, uniqueness, diversity, and relevance to the given marked labels from the set of reference labels. Cluster refining 125 inspects the correctness of clusters and the associated marked labels. If an irrelevance is found for a cluster and the associated marked label, the cluster is discarded. For each cluster of the marked labels, one or more embedded vectors close to the centroid are selected.

Using the selected clusters obtained from cluster refining 125 model, representative embedded vectors 140 are generated by employing a statistical model 135 such as medoid, principal component analysis (PCA), random sampling, or by training a simple machine-learning algorithm e.g., k-NN to predict most representative examples within a cluster. In some embodiments, the statistical model 135 is configured to compute a weighted average of the selected embedded vectors within a cluster with similar weights. The obtained representative embedded vectors 140 may be utilized in probability optimization process 145 to calculate a probability threshold.

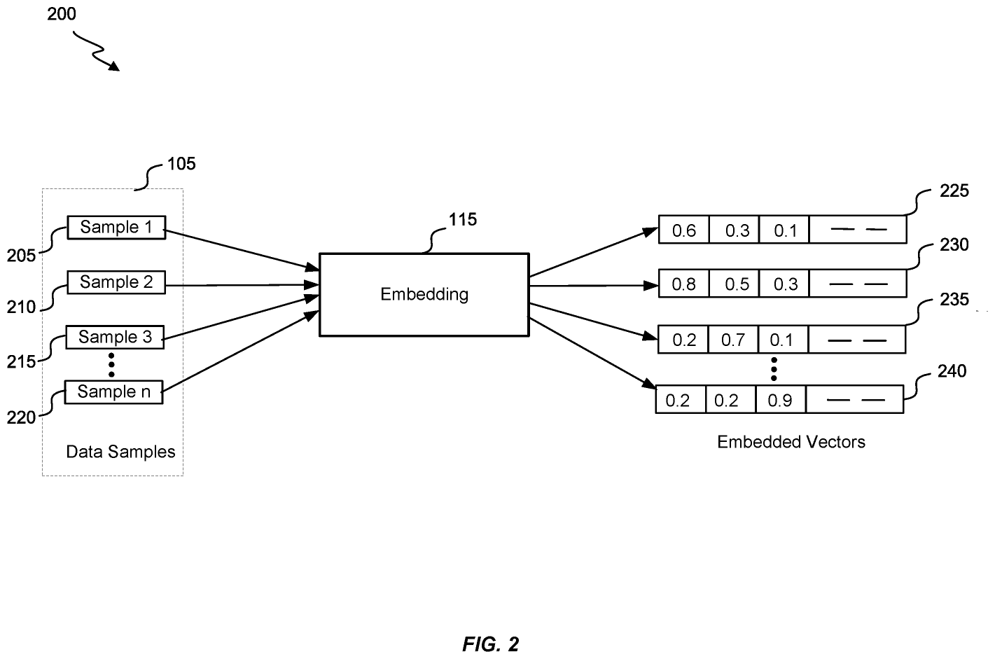

FIG. 2 illustrates generation of embedded vectors from a set of data samples using an embedding model in accordance with some embodiments of the disclosure. An embedding model 115 can be used before identifying the patterns through clustering. The data samples can be converted in a suitable format for example, for text data, many techniques like Word2Vec, GloVe, or pre-trained transformer models (e.g., BERT) may be used to convert words or sentences into dense vector embeddings called embedded vectors. Different samples of data (e.g., 205, 210, 215, 220) are used to generate embedding vectors (e.g., 225, 230, 235 and 240) using an embedding model 115. For pictorial data, neural networks may be used to extract features that serve as embeddings. However, for numerical data, features may be normalized, which can be considered as embeddings. For other types of data, various domain-specific embedding methods or feature engineering techniques can be used.

These embedded vectors 225, 230, 235 and 240 are useful because they may allow to represent complex, high-dimensional data in a more compact and meaningful form. The process of learning embeddings can help capture semantic relationships and patterns within the data, which is valuable for both clustering and learning tasks. These learned representations may enable the model to work effectively with diverse data types and achieve better generalization when provided with limited labeled examples. The computer-implemented method 100 may combine the power of embedding and clustering to prepare and analyze labeled data to extract representative embedded vectors, thereby enhancing the ability of a model to identify patterns accurately.

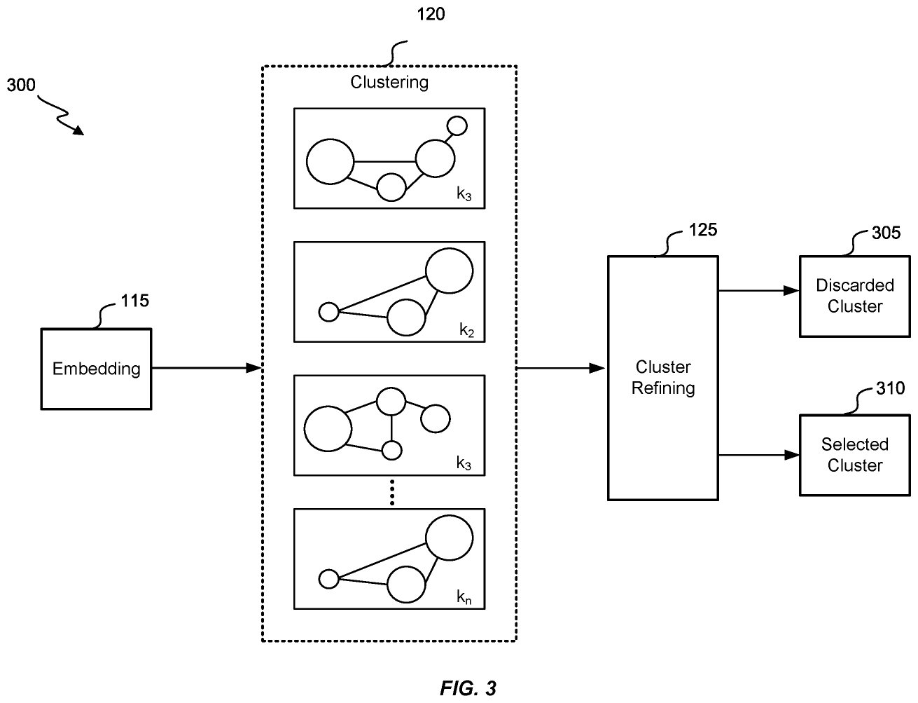

FIG. 3 is an example illustration of clustering and cluster refining method of embedded vectors for each label from a set of reference labels after generating embedded vectors. The embedded vectors can be further divided into clusters by the process of clustering 120, where data points inside a cluster are more similar than the data points in other clusters. It can group similar data points together, which can reveal underlying structures or classes in the data. The process of clustering can be done by various methods, for example, by k-means where the user specifies factors like the number of clusters and the distance metric is used to measure similarity between the embedded vectors. On the other hand, dynamic clustering may allow the clustering algorithm to determine the optimal number of clusters or adapt to the data. This can be useful when there is uncertainty about the appropriate number of clusters or when the data is not well structured. Dynamic clustering algorithms may use criteria like the silhouette score, which quantifies the quality of clusters, to decide the number of clusters automatically. The choice of the type of clustering may vary depending on the specific needs and characteristics of data. As shown in FIG. 3, the process of clustering may be done on the set of embedded vectors produced by embedding model 115, which results in the creation of multiple clusters for each label. Various provisional or placeholder labels are assigned to each cluster based on the contents of the data points within the cluster.

After clustering, each cluster typically may be inspected for the given set of reference labels. Custer refining 125 is performed where a user is provided the data samples 105 associated with the embedded vectors for each marked label to inspect the correctness of each cluster. In some embodiments, a human annotator performs inspection to check the validity of clusters to the given marked label from the set of reference labels. The embedded vectors associated with one or more invalid clusters are dropped 305. Correspondingly, the number of clusters are updated, and the selected clusters 310 are used for extracting representative embedded vectors.

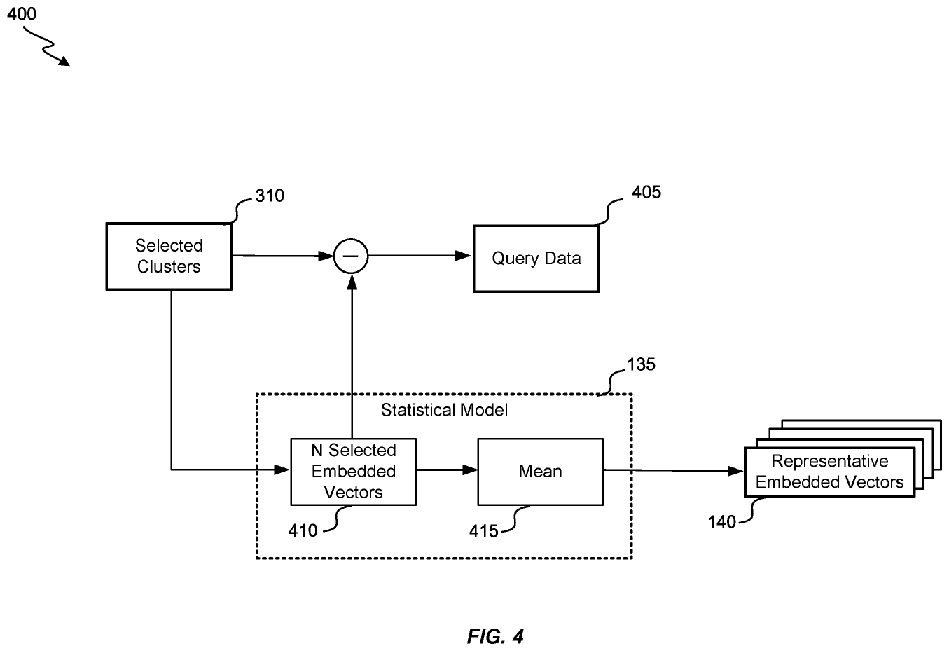

FIG. 4 is a block diagram of determining representative embedded vectors from a statistical model to perform one or more aspects of the disclosure described herein. The cluster refining 125 process separates the selected clusters 130 from the discarded clusters 305. The set of selected clusters 130 is fed into a statistical model 135 where N embedded vectors are selected for each cluster. The number N refers to the number of selected embedded vectors 410 for each cluster from a set of selected clusters 310. The statistical model 135 may be configured such that the weight of N selected embedded vectors 410 within each of the cluster is the same. The selected embedded vectors of clusters may be those that are closest to the centroid from the set of selected clusters 130. The value of N may be different for each cluster within a given label. An average 415 is obtained for each cluster within a given label for the N selected embedded vectors 410 that represent the representative embedded vectors 140. The other methods of selecting N embedded vectors may include choosing the centroid vector of each cluster as representative embedded vector 140, randomly sampling a fixed number of text strings from each cluster, using density-based criteria to select text strings focusing on areas with a high density of text strings within the cluster. Furthermore, query data 405 can be generated by subtracting the N embedded vectors 410 of each cluster from the embedded vectors of the selected clusters 130. The query data 405 is utilized in the probability optimization process 145 to generate a probability threshold for improving the prediction accuracy of the model trained on the extracted representative embedded vectors.

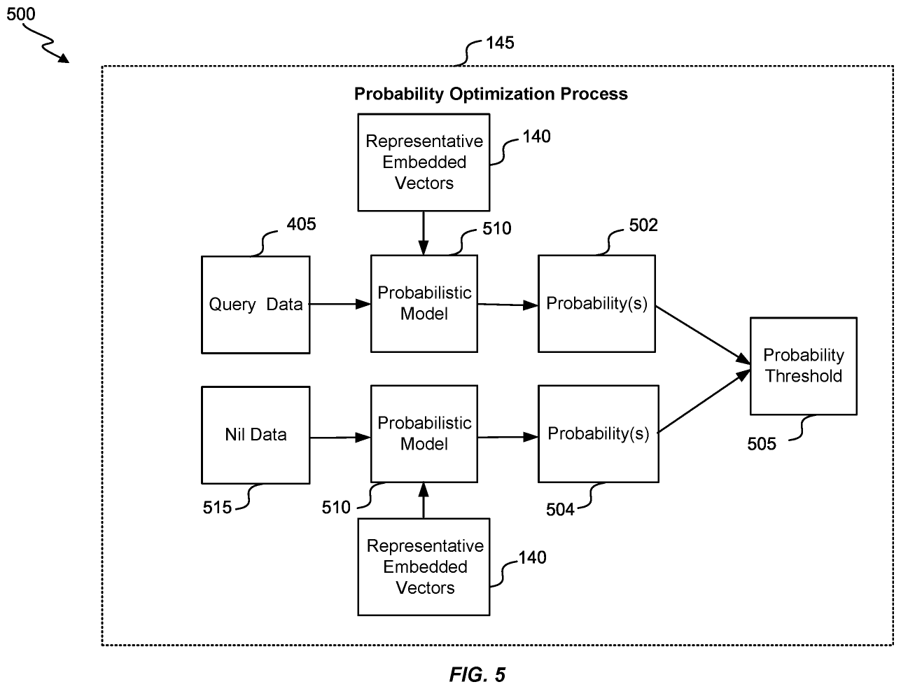

FIG. 5 is an example illustration of the probability optimization process of FIG. 1 generating a probability threshold for each label from the set of reference labels. The probability optimization process 145 is initiated by obtaining a set of query data 405 and nil data 515. The nil data 515 comprises of the data samples that do not correspond to the reference label set. The embedded vectors from the query data 405 are fed into a probabilistic model 510 such as GMM, SoftMax, multinomial logistic regression, hierarchal SoftMax function or any machine-learning model trained on representative embedded vectors that generates a probability of belonging to the given labels for a query. For the given query data 405, the probabilistic model 510 generates a probability(s) 502 and a prediction(s) corresponding to a given marked label from the set of reference labels that may be based on a similarity metric. The similarity metric can measure the similarity between the embedded vector of the given query data 405 and the representative embedded vectors 140. The similarity metrics may include cosine similarity, Euclidean distance, or other distance measures, depending on the nature of data.

Similarly, for the embedded vectors from given nil data 515, the probabilistic model 510 generates a probability(s) 504 and a prediction(s) corresponding to a given marked label from the set of reference labels based on a similarity metric. The similarity metric measures the similarity between the embedded vectors of given nil data 515 and the representative embedded vectors 140. The probability(s) obtained from the query data 405 and nil data 515 are utilized to obtain a probability threshold 505. The probability(s) 502 of query data 405 is compared with the probability(s) 504 obtained for nil data 515 to find the probability threshold 505 for each label. In some embodiments, the probability threshold 505 for a given label may be estimated by calculating the probability distributions for the nil embedded vectors and the query embedded vectors that belong to a particular label for a set of bins. From the probability distribution, the signal-to-nil ratio (SNR) for each bin is calculated, where the signal refers to the sum of probabilities of query data for a range of bins. The probability with highest SNR in the probability distribution is selected as a probability threshold 505 for a given label.

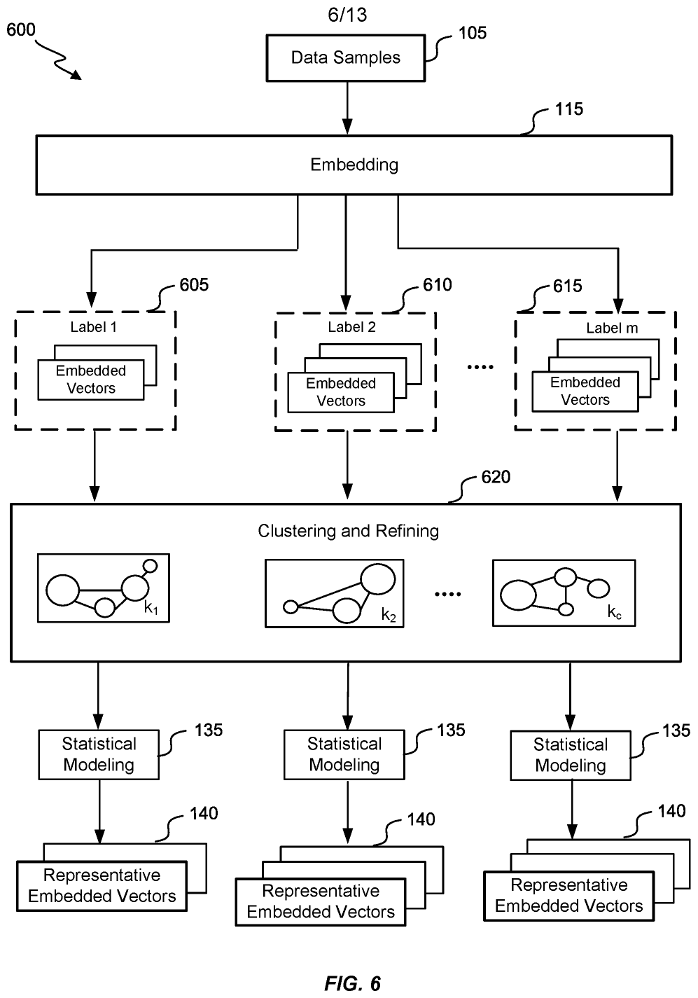

FIG. 6 illustrates a method of determining representative embedded vectors from a set of data samples with different labels in accordance with some embodiments of the disclosure. The method includes accessing a set of data samples 105 from imperfect labeled data. The data samples 105 can be preprocessed depending on the nature of data or the task at hand. One or more marked labels assigned to these embedded vectors from a set of referenced labels are retrieved. For example, if the set of reference labels have m marked labels e.g., label 1 (605), label 2 (610) up to label m (615), a subset of embedded vectors is assigned to each label. After identification, clustering and cluster refining 620 is performed using the embedded vectors of the data samples 105 within the subset associated with each marked label. As a result of clustering, (610) and kc number of clusters may be assigned to label m. The k number of clusters may be different for each label. After cluster refining, a subset of embedded vectors that are closer to the centroid may be selected. Using these selected embedded vectors, representative embedded vectors 140 may be generated by employing a statistical model 135. The statistical technique may calculate the average of the selected embedded vectors within each cluster and consider the calculated mean embedded vectors as representative embedded vectors.

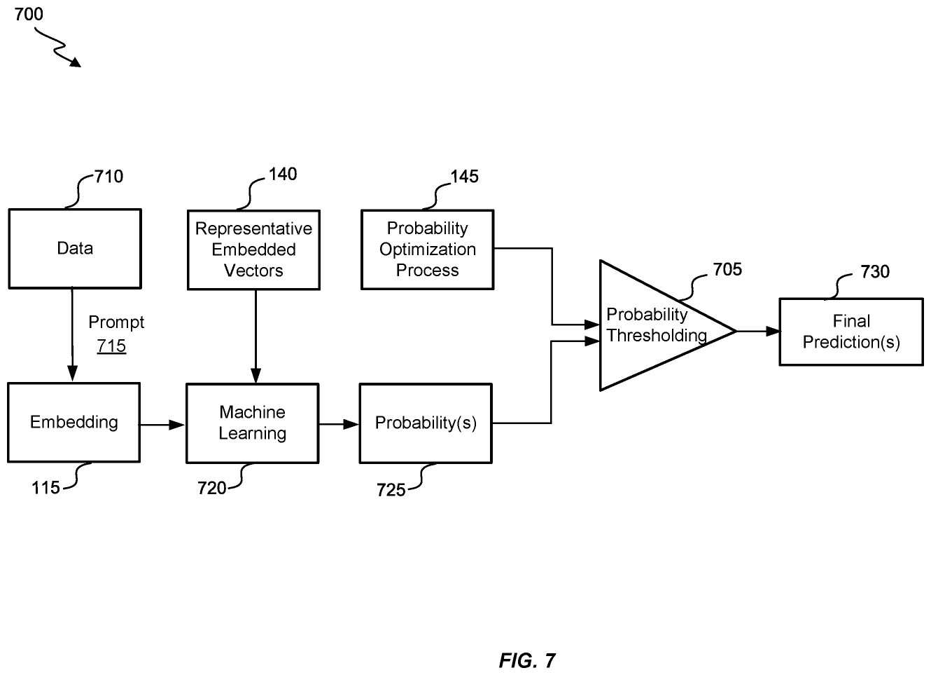

FIG. 7 illustrates an example method to obtain a final prediction(s) for a given prompt by using the representative embedded vectors 140 extracted in the method of FIG. 1. The representative embedded vectors 140 are fed into a machine-learning model 720 that generates a final prediction(s) 730 for a given prompt 715 from a set of data 710. Data 710 can be obtained from the set of data samples 105 or it can be obtained from an independent source. The prompt 715 is fed into the embedding model 115 generating the corresponding embedded vector, which is further given to the machine-learning model 155 that is trained on the representative embedded vectors 140. There may be various types of machine-learning models, depending on the specific task and objectives. The machine-learning 155 model may include supervised learning models, unsupervised learning models, semi-supervised learning models, transfer learning models utilizing pre-trained models on large datasets and fine-tuned with the representative examples, ensemble models, time series models if the prompt 715 exhibits temporal patterns, reinforcement learning for tasks involving sequential decision-making, NLP models or transformer-based architectures for text classification, and language generation. The extracted representative embedded vectors 140 may also be used in a machine-learning model 155 working as a recommendation system (e.g., for collaborative filtering, content-based filtering) and graph neural networks in tasks like node classification, link prediction, and community detection. These machine-learning models 720 can be trained using the representative embedded vectors 140 extracted from method 110.

For the given prompt 715, the machine-learning model 720 may generate a probability(s) 725 and a prediction(s) corresponding to a given marked label from the set of reference labels based on a similarity metric. The similarity metric measures the similarity between the given prompt 715 and the representative embedded vectors 140.

The thresholding is performed 705 on probability(s) 725 obtained from the machine-learning model 720, in which probability of a prompt 715 is compared with the probability threshold obtained from the probability optimization process 145. The result of the probability thresholding 705 is used to obtain a final prediction(s) 730. If the predicted probability(s) 725 of the prompt 715 obtained from machine-learning model 720 for known labels is above the probability threshold obtained from the probability optimization process 145, the prediction is considered accurate. If the probability(s) 725 of the machine-learning model is below this probability threshold for the given label, the prompt 715 is designated as nil data 175.

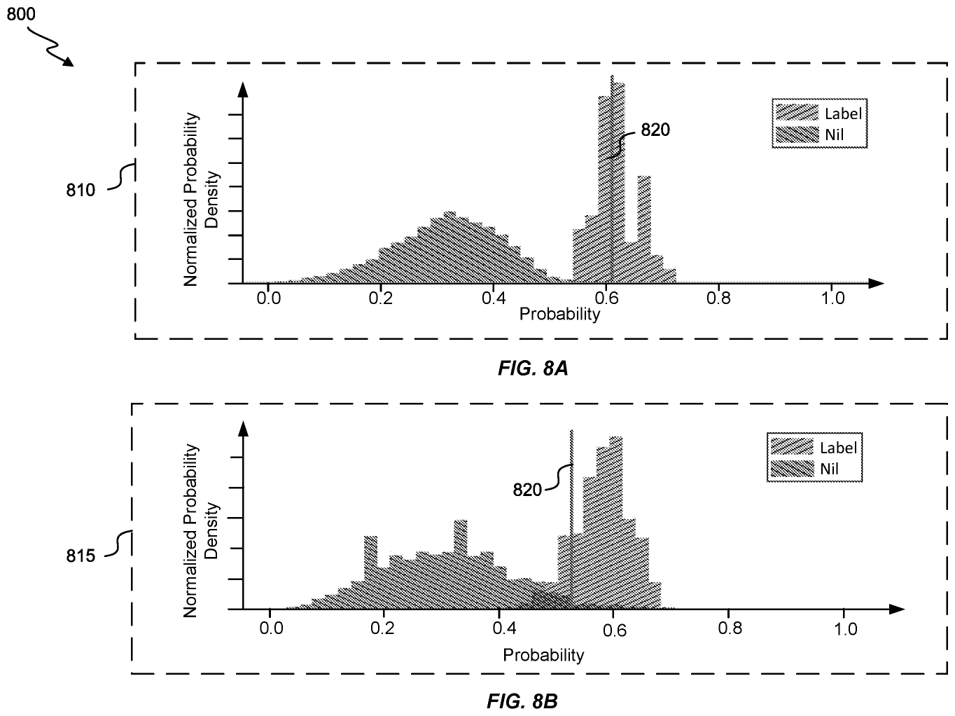

FIG. 8A illustrates an example of normalized probability distributions of embedded vectors for a given label in the set of reference labels versus embedded vectors of nil label to visualize the probability threshold calculated in the method of FIG. 5. The probability distributions for both embedded vectors of query data and embedded vectors of nil data can be constructed using e.g., histograms, kernel density estimation or other statistical techniques to model the distributions. The probability threshold can be estimated by calculating the SNR for a set of bins of the constructed probability distributions. As an exemplary implementation, probability optimization process may be performed by taking as input the probability scores of two sets of data: query data and nil data. The query data represents the “signal” to detect or classify, while the nil data serves as the background or “nil” reference representing the samples that do not belong to a given set of labels. A set of probability bins or thresholds are defined that represent intervals of probability scores within a specified range (e.g., from 0 to 1) that will be evaluated. For each probability bin, the probability optimization process may calculate the SNR. For the signal (query) set, it may calculate the sum of the signal data points whose probability scores are above the current bin threshold. This sum represents the “signal.” For the nil set, it may calculate the sum of the nil data points whose probability scores are above the same bin threshold. This sum represents the “background” or “noise.” The SNR may be computed as the ratio of the signal to the background. The process may iterate through the probability bins and select the bin that maximizes the SNR. This bin threshold may be considered the probability threshold that can be used for data classification or other purposes. The goal of this process is to find the threshold that maximizes the separation between the signal (query data) and the nil data while considering the background noise. This threshold can be useful for classifying new data points based on the probability scores.

Similarly, FIG. 8B illustrates another example of normalized probability distributions of embedded vectors for another label in the set of reference labels versus embedded vectors of nil label to visualize the probability threshold calculated in the method of FIG. 5.

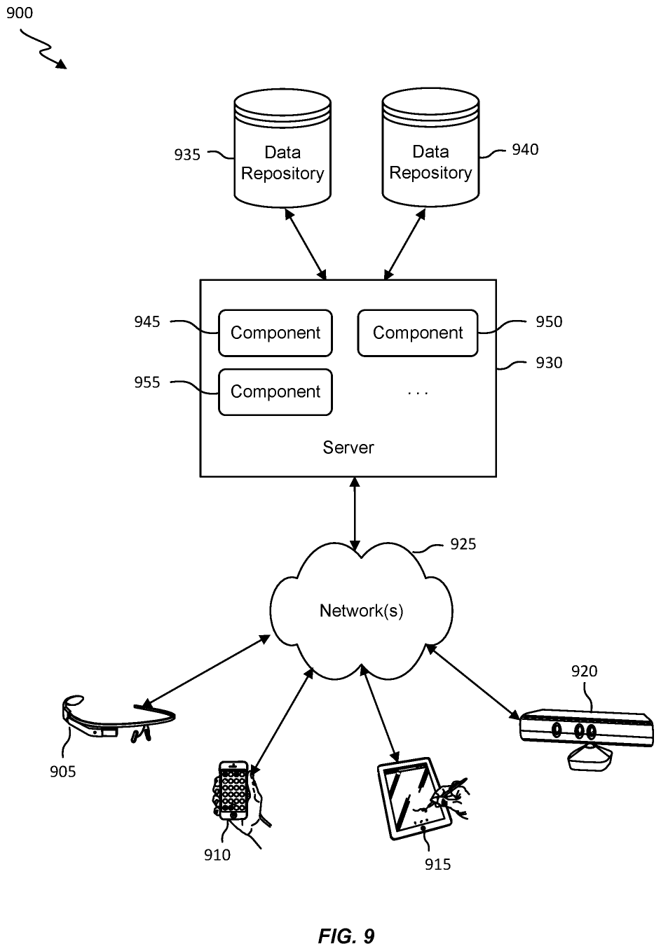

FIG. 9 depicts a simplified diagram of a distributed system 900 for implementing method 100 of FIG. 1. In the illustrated embodiment, distributed system 900 includes one or more client computing devices 905, 910, 915, and 920, coupled to a server 930 via one or more communication networks 925. Clients computing devices 905, 910, 915, and 920 may be configured to execute one or more applications.

In various aspects, server 930 may be adapted to run one or more services or software applications that enable techniques for determining representative samples from a large imperfectly labeled dataset. In certain aspects, server 930 may also provide other services or software applications that can include non-virtual and virtual environments. In some respects, these services may be offered as web-based or cloud services, such as under a Software as a Service (SaaS) model to the users of client computing devices 905, 910, 915, and/or 920. Users operating client computing devices 905, 910, 915, and/or 920 may in turn utilize one or more client applications to interact with server 930 to utilize the services provided by these components. Furthermore, client computing devices 905, 910, 915, and/or 920 may in turn utilize one or more client applications for manual annotation of clusters during cluster refining process 125.

In the configuration depicted in FIG. 9, server 930 may include one or more components 945, 950 and 955 that implement the functions performed by server 930. These components may include software components that may be executed by one or more processors, hardware components, or combinations thereof. It should be appreciated that various different system configurations are possible, which may be different from distributed system 900. The embodiment shown in FIG. 9 is thus one example of a distributed system for implementing an embodiment system and is not intended to be limiting.

Users may use client computing devices 905, 910, 915, and/or 920 for determining representative samples from a large imperfectly labeled dataset via various machine-learning models such as regression, artificial neural networks, k-means clustering, hierarchical clustering etc. in accordance with the teachings of this disclosure. A client device may provide an interface that enables a user of the client device to interact with the client device. The client device may also output information to the user via this interface. Although FIG. 9 depicts only four client computing devices, any number of client computing devices may be supported.

The client devices may include various types of computing systems such as portable handheld devices, general purpose computers such as personal computers and laptops, workstation computers, wearable devices, gaming systems, thin clients, various messaging devices, sensors or other sensing devices, and the like. These computing devices may run various types and versions of software applications and operating systems (e.g., Microsoft Windows® Apple Macintosh®, UNIX® or UNIX-like operating systems, Linux or Linux-like operating systems such as Google Chrome™ OS) including various mobile operating systems (e.g., Microsoft Windows Mobile®, iOS®, Windows Phone®, Android™, BlackBerry®, Palm OS®). Portable handheld devices may include cellular phones, smartphones, (e.g., an iPhone®), tablets (e.g., iPad®), personal digital assistants (PDAs), and the like. Wearable devices may include Google Glass® head mounted display, and other devices. Gaming systems may include various handheld gaming devices, Internet-enabled gaming devices (e.g., a Microsoft Xbox® gaming console with or without a Kinect® gesture input device, Sony PlayStation® system, various gaming systems provided by Nintendo®, and others), and the like. The client devices may be capable of executing various applications such as various Internet-related apps, communication applications (e.g., E-mail applications, short message service (SMS) applications) and may use various communication protocols.

Network(s) 925 may be any type of network familiar to those skilled in the art that can support data communications using any of a variety of available protocols, including without limitation TCP/IP (transmission control protocol/Internet protocol), SNA (systems network architecture), IPX (Internet packet exchange), AppleTalk®, and the like. Merely by way of example, network(s) 925 can be a local area network (LAN), networks based on Ethernet, Token-Ring, a wide-area network (WAN), the Internet, a virtual network, a virtual private network (VPN), an intranet, an extranet, a public switched telephone network (PSTN), an infra-red network, a wireless network (e.g., a network operating under any of the Institute of Electrical and Electronics (IEEE) 1002.11 suite of protocols, Bluetooth®, and/or any other wireless protocol), and/or any combination of these and/or other networks.

Server 930 may be composed of one or more general purpose computers, specialized server computers (including, by way of example, PC (personal computer) servers, UNIX® servers, mid-range servers, mainframe computers, rack-mounted servers, etc.), server farms, server clusters, or any other appropriate arrangement and/or combination. Server 930 can include one or more virtual machines running virtual operating systems, or other computing architectures involving virtualization such as one or more flexible pools of logical storage devices that can be virtualized to maintain virtual storage devices for the server. In various aspects, server 930 may be adapted to run one or more services or software applications that provide the functionality described in the foregoing disclosure.

The computing systems in server 930 may run one or more operating systems including any of those discussed above, as well as any commercially available server operating system. Server 930 may also run any of a variety of additional server applications and/or mid-tier applications, including HTTP (hypertext transport protocol) servers, FTP (file transfer protocol) servers, CGI (common gateway interface) servers, JAVA® servers, database servers, and the like. Exemplary database servers include without limitation those commercially available from Oracle®, Microsoft®, Sybase®, IBM® (International Business Machines), and the like.

In some implementations, server 930 may include one or more applications to implement various machine-learning algorithms and the method of FIG. 1. The data samples 105 of FIG. 1 may include data of various forms such as text data, audio data, video data, time-series data, real-time data and/or image data. As an example, in case where the data samples are text or image that may include, but are not limited to, Twitter® feeds, Facebook® updates or real-time updates received from one or more third party information sources and continuous data streams, which may include real-time events related to sensor data applications, financial tickers, network performance measuring tools (e.g., network monitoring and traffic management applications), clickstream analysis tools, automobile traffic monitoring, and the like. Server 930 may also include one or more applications to display the output of various processes of system 100 via one or more display devices of client computing devices 905, 910, 915, and 920.

Distributed system 900 may also include one or more data repositories 935, 940. These data repositories may be used to store data samples 105 and other information in certain aspects. For example, one or more of the data repositories 935, 940 may be used to store the reference label for the data samples 105. Data repositories 935, 940 may reside in a variety of locations. For example, a data repository used by server 930 may be local to server 930 or may be remote from server 930 and in communication with server 930 via a network-based or dedicated connection. Data repositories 935, 940 may be of different types. In certain aspects, a data repository used by server 930 may be a database, for example, a relational database, such as databases provided by Oracle Corporation® and other vendors. One or more of these databases may be adapted to enable storage, update, and retrieval of data to and from the database in response to structured query language (SQL)-formatted commands.

In certain aspects, one or more data repositories 935, 940 may also be used by applications to store application data. The data repositories used by applications may be of different types such as, for example, a key-value store repository, an object store repository, or a general storage repository supported by a file system.

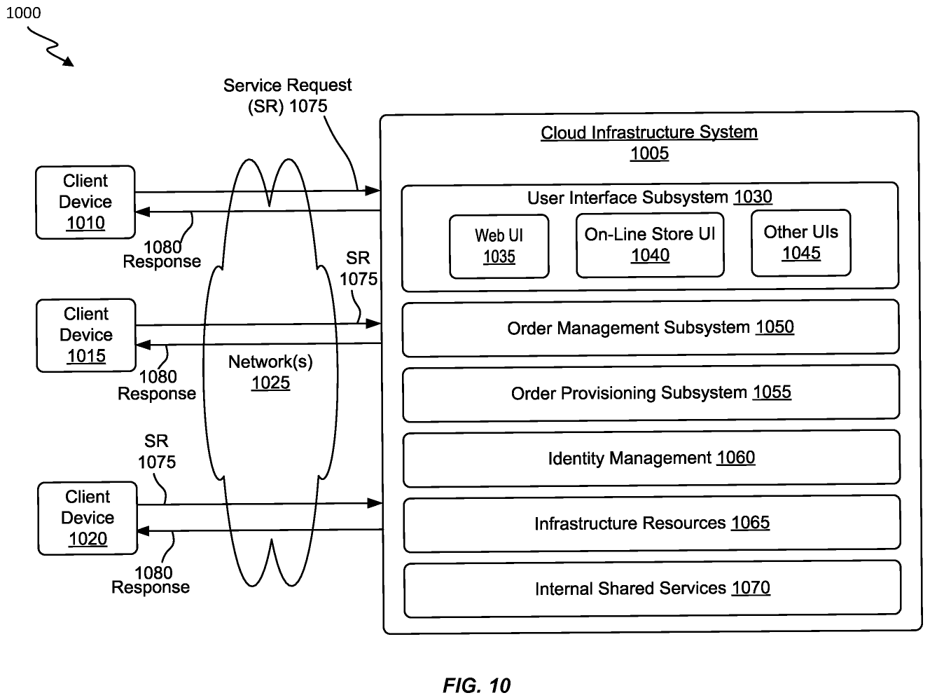

In certain aspects, the techniques for determining the representative samples from a large imperfectly labeled dataset described in this disclosure may be offered as services via a cloud environment. FIG. 10 is a simplified block diagram of a cloud-based system environment in which various services of server 930 of FIG. 9 may be offered as cloud services, in accordance with certain aspects. In the embodiment depicted in FIG. 10, cloud infrastructure system 1005 may provide one or more cloud services that may be requested by users using one or more client computing devices 1010, 1015, and 1020. Cloud infrastructure system 1005 may comprise one or more computers and/or servers that may include those described for server 930. The computers in cloud infrastructure system 1005 may be organized as general-purpose computers, specialized server computers, server farms, server clusters, or any other appropriate arrangement and/or combination.

Network(s) 1025 may facilitate communication and exchange of data between clients 1010, 1015, and 1020 and cloud infrastructure system 1005. Network(s) 1025 may include one or more networks. The networks may be of the same or different types. Network(s) 1025 may support one or more communication protocols, including wired and/or wireless protocols, for facilitating the communications.

The embodiment depicted in FIG. 10 is only one example of a cloud infrastructure system and is not intended to be limiting. It should be appreciated that, in some other aspects, cloud infrastructure system 1005 may have more or fewer components than those depicted in FIG. 10, may combine two or more components, or may have a different configuration or arrangement of components. For example, although FIG. 10 depicts three client computing devices, any number of client computing devices may be supported in alternative aspects.

The term cloud service is generally used to refer to a service that is made available to users on demand and via a communication network such as the Internet by systems (e.g., cloud infrastructure system 1005) of a service provider. Typically, in a public cloud environment, servers and systems that make up the cloud service provider's system are different from the client's own on-premises servers and systems. The cloud service provider's systems are managed by the cloud service provider. Clients can thus avail themselves of cloud services provided by a cloud service provider without having to purchase separate licenses, support, or hardware and software resources for the services. For example, a cloud service provider's system may host an application, and a user may, via a network 1025 (e.g., the Internet), on demand, order and use the application without the user having to buy infrastructure resources for executing the application. Cloud services are designed to provide easy, scalable access to applications, resources, and services. Several providers offer cloud services. For example, several cloud services are offered by Oracle Corporation® of Redwood Shores, California, such as middleware services, database services, Java cloud services, and others.

In certain aspects, cloud infrastructure system 1005 may provide one or more cloud services using different models such as under a Software as a Service (SaaS) model, a Platform as a Service (PaaS) model, an Infrastructure as a Service (IaaS) model, and others, including hybrid service models. Cloud infrastructure system 1005 may include a suite of applications, middleware, databases, and other resources that enable provision of the various cloud services.

A SaaS model enables an application or software to be delivered to a client over a communication network like the Internet, as a service, without the client having to buy the hardware or software for the underlying application. For example, a SaaS model may be used to provide clients access to on-demand applications that are hosted by cloud infrastructure system 1005. Examples of SaaS services provided by Oracle Corporation® include, without limitation, various services for human resources/capital management, client relationship management (CRM), enterprise resource planning (ERP), supply chain management (SCM), enterprise performance management (EPM), analytics services, social applications, and others.

An IaaS model is generally used to provide infrastructure resources (e.g., servers, storage, hardware, and networking resources) to a client as a cloud service to provide elastic compute and storage capabilities. Various IaaS services are provided by Oracle Corporation®.

A PaaS model is generally used to provide, as a service, platform and environment resources that enable clients to develop, run, and manage applications and services without the client having to procure, build, or maintain such resources. Examples of PaaS services provided by Oracle Corporation® include, without limitation, Oracle Java Cloud Service (JCS), Oracle Database Cloud Service (DBCS), data management cloud service, various application development solutions services, and others.

Cloud services are generally provided on an on-demand self-service basis, subscription-based, elastically scalable, reliable, highly available, and secure manner. For example, a client, via a subscription order, may order one or more services provided by cloud infrastructure system 1005. Cloud infrastructure system 1005 then performs processing to provide the services requested in the client's subscription order. Cloud infrastructure system 1005 may be configured to provide one or even multiple cloud services.

Cloud infrastructure system 1005 may provide cloud services via different deployment models. In a public cloud model, cloud infrastructure system 1005 may be owned by a third-party cloud services provider and the cloud services are offered to any general public client, where the client can be an individual or an enterprise. In certain other aspects, under a private cloud model, cloud infrastructure system 1005 may be operated within an organization (e.g., within an enterprise organization) and services provided to clients that are within the organization. For example, the clients may be various departments of an enterprise such as the Human Resources department, the payroll department, etc. or even individuals within the enterprise. In certain other aspects, under a community cloud model, the cloud infrastructure system 1005 and the services provided may be shared by several organizations in a related community. Various other models such as hybrids of the above-mentioned models may also be used.

Client computing devices 1010, 1015, and 1020 may be of several types (such as devices 905, 910, 915, and 920 depicted in FIG. 9) and may be capable of operating one or more client applications. A user may use a client device to interact with cloud infrastructure system 1005, such as to request a service provided by cloud infrastructure system 1005. For example, a user may use a client device to perform cluster refining process 125.

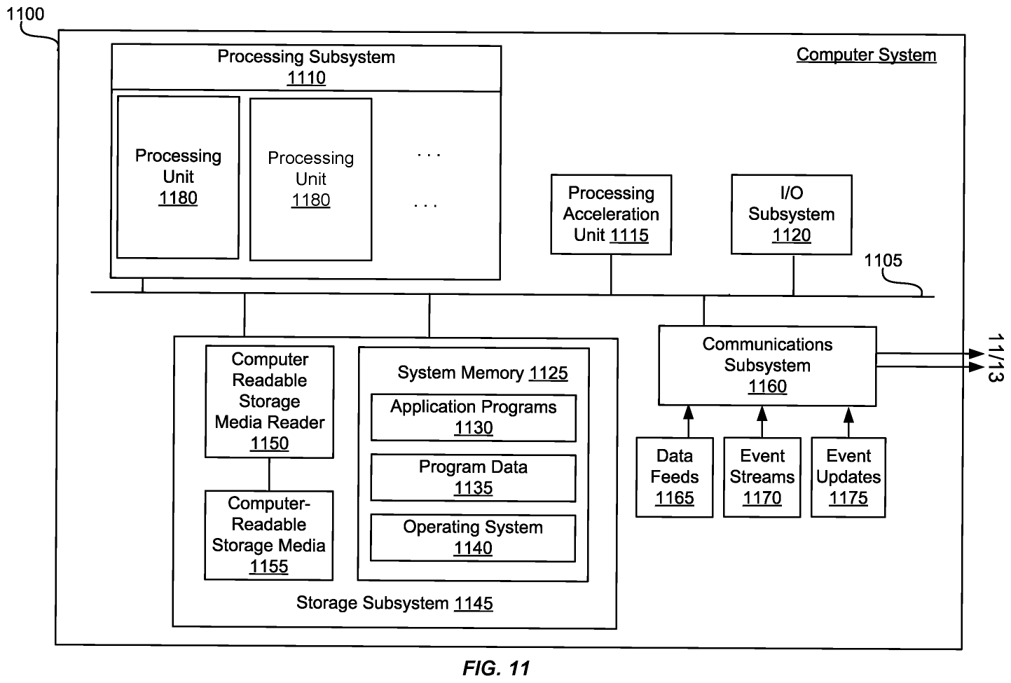

As depicted in the embodiment in FIG. 10, cloud infrastructure system 1005 may include infrastructure resources 1065 that can be utilized for facilitating the provision of various cloud services offered by cloud infrastructure system 1005. These services include 1110,1115,1120,1125,1130 as shown in FIG. 11. Infrastructure resources 1065 may include, for example, processing resources, storage or memory resources, networking resources, and the like.

In certain aspects, to facilitate efficient provisioning of these resources for supporting the various cloud services provided by cloud infrastructure system 1005 for different clients, the resources may be bundled into sets of resources or resource modules (also referred to as “pods”). Each resource module or pod may comprise a pre-integrated and optimized combination of resources of one or more types. In certain aspects, different pods may be pre-provisioned for different types of cloud services. For example, a first set of pods may be provisioned for a database service, a second set of pods, which may include a different combination of resources than a pod in the first set of pods, may be provisioned for Java service, and the like. For some services, the resources allocated for provisioning the services may be shared between the services.

Cloud infrastructure system 1005 may itself internally use services 1070 that are shared by different components of cloud infrastructure system 1005 and which facilitate the provisioning of services by cloud infrastructure system 1005. These internal shared services may include, without limitation, a security and identity service, an integration service, an enterprise repository service, an enterprise manager service, a virus scanning and whitelist service, a high availability, backup and recovery service, service for enabling cloud support, an email service, a notification service, a file transfer service, and the like.

Cloud infrastructure system 1005 may comprise multiple subsystems. These subsystems may be implemented in software, or hardware, or combinations thereof. As depicted in FIG. 10, the subsystems may include a user interface subsystem 1030 that enables users or clients of cloud infrastructure system 1005 to interact with cloud infrastructure system 1005. User interface subsystem 1030 may include various interfaces such as a web interface 1035, an online store interface 1040 where cloud services provided by cloud infrastructure system 1005 are advertised and are purchasable by a consumer, and other interfaces 1045. For example, a client may, using a client device, request (service request 1075) one or more services provided by cloud infrastructure system 1005 using one or more of interfaces 1035, 1040, and 1045. For example, a client may access the online store, browse cloud services offered by cloud infrastructure system 1005, and place a subscription order for one or more services offered by cloud infrastructure system 1005 that the client wishes to subscribe to. The service request may include information identifying the client and one or more services that the client desires to subscribe to. For example, a client may place a subscription order for a Chabot related service offered by cloud infrastructure system 1005. As part of the order, the client may provide information identifying for input (e.g., utterances).

In certain aspects, such as the embodiment depicted in FIG. 10, cloud infrastructure system 1005 may comprise an order management subsystem (OMS) 1050 that is configured to process the new order. As part of this processing, OMS 1050 may be configured to: create an account for the client, if not done already; receive billing and/or accounting information from the client that is to be used for billing the client for providing the requested service to the client; verify the client information; upon verification, book the order for the client; and orchestrate various workflows to prepare the order for provisioning.

Once properly validated, OMS 1050 may then invoke the order provisioning subsystem (OPS) 1055 that is configured to provision resources for the order including processing, memory, and networking resources. The provisioning may include allocating resources for the order and configuring the resources to facilitate the service requested by the client order. The manner in which resources are provisioned for an order and the type of the provisioned resources may depend upon the type of cloud service that has been ordered by the client. For example, according to one workflow, OPS 1055 may be configured to determine the particular cloud service being requested and identify a number of pods that may have been pre-configured for that particular cloud service. The number of pods that are allocated for an order may depend upon the size/amount/level/scope of the requested service. For example, the number of pods to be allocated may be determined based upon the number of users to be supported by the service, the duration of time for which the service is being requested, and the like. The allocated pods may then be customized for the particular requesting client for providing the requested service.

Cloud infrastructure system 1005 may send a response or notification 1080 to the requesting client to indicate when the requested service is now ready for use. In some instances, information (e.g., a link) may be sent to the client that enables the client to start using and availing the benefits of the requested services.

Cloud infrastructure system 1005 may provide services to multiple clients. For each client, cloud infrastructure system 1005 is responsible for managing information related to one or more subscription orders received from the client, maintaining client data related to the orders, and providing the requested services to the client. Cloud infrastructure system 1005 may also collect usage statistics regarding a client's use of subscribed services. For example, statistics may be collected for the amount of storage used, the amount of data transferred, the number of users, and the amount of system up time and system down time, and the like. This usage information may be used to bill the client. Billing may be done, for example, on a monthly cycle.

Cloud infrastructure system 1005 may provide services to multiple clients in parallel. Cloud infrastructure system 1005 may store information for these clients, including possibly proprietary information. In certain aspects, cloud infrastructure system 1005 comprises an identity management subsystem (IMS) 1060 that is configured to manage client's information and provide the separation of the managed information such that information related to one client is not accessible by another client. IMS 1060 may be configured to provide various security-related services such as identity services, such as information access management, authentication and authorization services, services for managing client identities and roles and related capabilities, and the like.

FIG. 11 illustrates an exemplary computer system 1100 that may be used to implement certain aspects. For example, in some aspects, computer system 1100 may be used to implement any of the systems for determining the representative samples from a large imperfectly labeled dataset shown in FIG. 1 and various servers and computer systems described above. As shown in FIG. 11, computer system 1100 includes various subsystems including a processing subsystem 1110 that communicates with a few other subsystems via a bus subsystem 1105. These other subsystems may include a processing acceleration unit 1115, an I/O subsystem 1120, a storage subsystem 1145, and a communications subsystem 1160. Storage subsystem 1145 may include non-transitory computer-readable storage media including storage media 1155 and a system memory 1125.

Bus subsystem 1105 provides a mechanism for letting the various components and subsystems of computer system 1100 communicate with each other as intended. Although bus subsystem 1105 is shown schematically as a single bus, alternative aspects of the bus subsystem may utilize multiple buses. Bus subsystem 1105 may be any of several types of bus structures including a memory bus or memory controller, a peripheral bus, a local bus using any of a variety of bus architectures, and the like. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard, and the like.

Processing subsystem 1110 controls the operation of computer system 1100 and may comprise one or more processors, application specific integrated circuits (ASICs), or field programmable gate arrays (FPGAs). The processors may include single core or multicore processors. The processing resources of computer system 1100 can be organized into one or more processing units 1180, 1180, etc. A processing unit may include one or more processors, one or more cores from the same or different processors, a combination of cores and processors, or other combinations of cores and processors. In some aspects, processing subsystem 1110 can include one or more special purpose co-processors such as graphics processors, digital signal processors (DSPs), or the like. In some aspects, some or all of the processing units of processing subsystem 1110 can be implemented using customized circuits, such as application specific integrated circuits (ASICs), or field programmable gate arrays (FPGAs).

In some aspects, the processing units in processing subsystem 1110 can execute instructions stored in system memory 1125 or on computer readable storage media 1155. In various aspects, the processing units can execute a variety of programs or code instructions and can maintain multiple concurrently executing programs or processes. At any given time, some, or all of the program code to be executed can be resident in system memory 1125 and/or on computer-readable storage media 1155 including potentially on one or more storage devices. Through suitable programming, processing subsystem 1110 can provide various functionalities described above. In instances where computer system 1100 is executing one or more virtual machines, one or more processing units may be allocated to each virtual machine.

In certain aspects, a processing acceleration unit 1115 may optionally be provided for performing customized processing or for off-loading some of the processing performed by processing subsystem 1110 to accelerate the overall processing performed by computer system 1100.

I/O subsystem 1120 may include devices and mechanisms for inputting information to computer system 1100 and/or for outputting information from or via computer system 1100. In general, use of the term input device is intended to include all possible types of devices and mechanisms for inputting information to computer system 1100. User interface input devices may include, for example, a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may also include motion sensing and/or gesture recognition devices such as the Microsoft Kinect® motion sensor that enables users to control and interact with an input device, the Microsoft Xbox® 360 game controller, devices that provide an interface for receiving input using gestures and spoken commands. User interface input devices may also include eye gesture recognition devices such as the Google Glass® blink detector that detects eye activity (e.g., “blinking” while taking pictures and/or making a menu selection) from users and transforms the eye gestures as inputs to an input device (e.g., Google Glass®). Additionally, user interface input devices may include voice recognition sensing devices that enable users to interact with voice recognition systems (e.g., Siri® navigator) through voice commands.

Other examples of user interface input devices include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, and medical ultrasonography devices. User interface input devices may also include, for example, audio input devices such as MIDI keyboards, digital musical instruments, and the like.

In general, use of the term output device is intended to include all possible types of devices and mechanisms for outputting information from computer system 1100 to a user or other computer. User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. For example, user interface output devices may include, without limitation, a variety of display devices that visually convey text, graphics, and audio/video information such as monitors, printers, speakers, headphones, automotive navigation systems, plotters, voice output devices, and modems.

Storage subsystem 1145 provides a repository or data store for storing information and data that is used by computer system 1100. Storage subsystem 1145 provides a tangible non-transitory computer-readable storage medium for storing the basic programming and data constructs that provide the functionality of some aspects. Storage subsystem 1145 may store software (e.g., programs, code modules, instructions) that when executed by processing subsystem 1110 provides the functionality described above. The software may be executed by one or more processing units of processing subsystem 1110. Storage subsystem 1145 may also provide a repository for storing data used in accordance with the teachings of this disclosure.

Storage subsystem 1145 may include one or more non-transitory memory devices, including volatile and non-volatile memory devices. As shown in FIG. 11, storage subsystem 1145 includes a system memory 1125 and a computer-readable storage media 1155. System memory 1125 may include a number of memories including a volatile main random-access memory (RAM) for storage of instructions and data during program execution and a non-volatile read only memory (ROM) or flash memory in which fixed instructions are stored. In some implementations, a basic input/output system (BIOS), containing the basic routines that help to transfer information between elements within computer system 1100, such as during start-up, may typically be stored in the ROM. The RAM typically contains data and/or program modules that are presently being operated and executed by processing subsystem 1110. In some implementations, system memory 1125 may include multiple different types of memory, such as static random-access memory (SRAM), dynamic random-access memory (DRAM), and the like.

By way of example, and not limitation, as depicted in FIG. 11, system memory 1125 may load application programs 1130 that are being executed, which may include various applications such as Web browsers, mid-tier applications, relational database management systems (RDBMS), etc., program data 1135, and an operating system 1140. By way of example, operating system 1140 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, Palm® OS operating systems, and others.

Computer-readable storage media 1155 may store programming and data constructs that provide the functionality of some aspects. Computer-readable media 1155 may provide storage of computer-readable instructions, data structures, program modules, and other data for computer system 1100. Software (programs, code modules, instructions) that, when executed by processing subsystem 1110 provides the functionality described above, may be stored in storage subsystem 1145. By way of example, computer-readable storage media 1155 may include non-volatile memory such as a hard disk drive, a magnetic disk drive, an optical disk drive such as a CD ROM, digital video disc (DVD), a Blu-Ray® disk, or other optical media. Computer-readable storage media 1155 may include, but is not limited to, Zip® drives, flash memory cards, universal serial bus (USB) flash drives, secure digital (SD) cards, DVD disks, digital video tape, and the like. Computer-readable storage media 1155 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, dynamic random access memory (DRAM)-based SSDs, magneto resistive RAM (MRAM) SSDs, and hybrid SSDs that use a combination of DRAM and flash memory based SSDs.

In certain aspects, storage subsystem 1145 may also include a computer-readable storage media reader 1150 that can further be connected to computer-readable storage media 1155. Reader 1150 may receive and be configured to read data from a memory device such as a disk, a flash drive, etc.

In certain aspects, computer system 1100 may support virtualization technologies, including but not limited to virtualization of processing and memory resources. For example, computer system 1100 may provide support for executing one or more virtual machines. In certain aspects, computer system 1100 may execute a program such as a hypervisor that facilitated the configuring and managing of the virtual machines. Each virtual machine may be allocated memory, compute (e.g., processors, cores), I/O, and networking resources. Each virtual machine generally runs independently of the other virtual machines. A virtual machine typically runs its own operating system, which may be the same as or different from the operating systems executed by other virtual machines executed by computer system 1100. Accordingly, multiple operating systems may potentially be run concurrently by computer system 1100.

Communications subsystem 1160 provides an interface to other computer systems and networks. Communications subsystem 1160 serves as an interface for receiving data from and transmitting data to other systems from computer system 1100. For example, communications subsystem 1160 may enable computer system 1100 to establish a communication channel to one or more client devices via the Internet for receiving and sending information from and to the client devices. For example, the communication subsystem may be used to transmit a response to a user regarding the inquiry for a Chabot.

Communication subsystem 1160 may support both wired and/or wireless communication protocols. For example, in certain aspects, communications subsystem 1160 may include radio frequency (RF) transceiver components for accessing wireless voice and/or data networks (e.g., using cellular telephone technology, advanced data network technology, such as 3G, 4G or EDGE (enhanced data rates for global evolution), Wi-Fi (IEEE 802.XX family standards, or other mobile communication technologies, or any combination thereof), global positioning system (GPS) receiver components, and/or other components. In some aspects communications subsystem 1160 can provide wired network connectivity (e.g., Ethernet) in addition to or instead of a wireless interface.

Communication subsystem 1160 can receive and transmit data in various forms. For example, in some aspects, in addition to other forms, communications subsystem 1160 may receive input communications in the form of structured and/or unstructured data feeds 1165, event streams 1170, event updates 1175, and the like. For example, communications subsystem 1160 may be configured to receive (or send) data feeds 1165 in real-time from users of social media networks and/or other communication services such as Twitter® feeds, Facebook® updates, web feeds such as Rich Site Summary (RSS) feeds, and/or real-time updates from one or more third party information sources.

In certain aspects, communications subsystem 1160 may be configured to receive data in the form of continuous data streams, which may include event streams 1170 of real-time events and/or event updates 1175, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 1160 may also be configured to communicate data from computer system 1100 to other computer systems or networks. The data may be communicated in various forms such as structured and/or unstructured data feeds 1165, event streams 1170, event updates 1175, and the like to one or more databases that may be in communication with one or more streaming data source computers coupled to computer system 1100.

Computer system 1100 can be one of various types, including a handheld portable device (e.g., an iPhone® cellular phone, an iPad® computing tablet, a personal digital assistant (PDA)), a wearable device (e.g., a Google Glass® head mounted display), a personal computer, a workstation, a mainframe, a kiosk, a server rack, or any other data processing system. Due to the ever-changing nature of computers and networks, the description of computer system 1100 depicted in FIG. 11 is intended only as a specific example. Many other configurations having more or fewer components than the system depicted in FIG. 11 are possible. Based on the disclosure and teachings provided herein, a person of ordinary skill in art can appreciate other ways and/or methods to implement the various aspects.

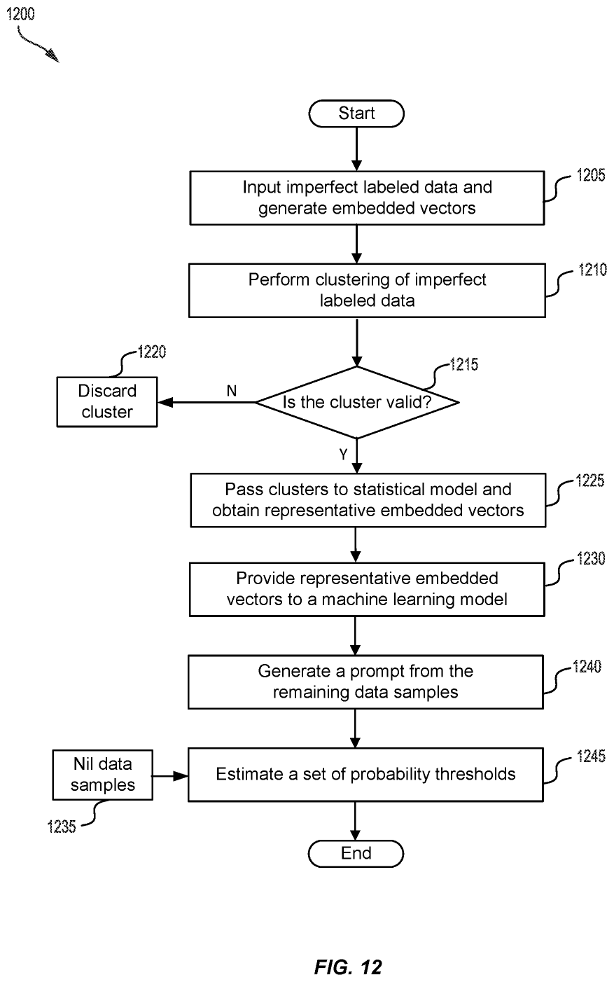

FIG. 12 illustrates an example flow 1200 of determining representative embedded vectors from a set of data samples and to find a set of probability thresholds for the given labels in accordance with some embodiments of the present disclosure. Referring to FIG. 12, at block 1205, an imperfect labeled data is obtained and embedded vectors are generated by passing the imperfect labeled data through an embedding model 115. At block 1210, a clustering 120 technique such as k-means clustering, adaptive k-means clustering, DBSCAN, or agglomerative clustering etc. is performed. A set of clusters are generated resulting in assigning the embedded vectors of each of at least some data samples 105 in the subset to a cluster within each marked label. The number of clusters can be predefined or can be selected using iterative techniques. Based on the selected number of clusters for each marked label, a set of clusters are generated using the embedded vectors of the data samples 105. The generation results in assigning the embedded vector of each of at least some data samples 105 in the subset to a cluster of the set of clusters.

Following the clustering 120 process, cluster refining 125 is performed to inspect the correctness of embedded vectors for each cluster. The decision block 1215 checks whether each cluster is valid or not and if the cluster is not valid, the cluster is discarded at block 1220. If the cluster is valid, the process proceeds to block 1225. At block 1225, embedded vectors for each cluster are passed to a statistical model 135 that generates representative embedded vectors 140 by computing the mean of one or more embedded vectors closer to the centroid. At block 1240, a prompt 180 is generated, such that it can be obtained from the data samples 105 or from an independent source. At block 1245, a set of probability thresholds are estimated for marked labels from the set of reference labels by a probability optimization process. The set of probability thresholds can be utilized to improve the prediction accuracy of a given prompt in the subsequent inferences and processing.

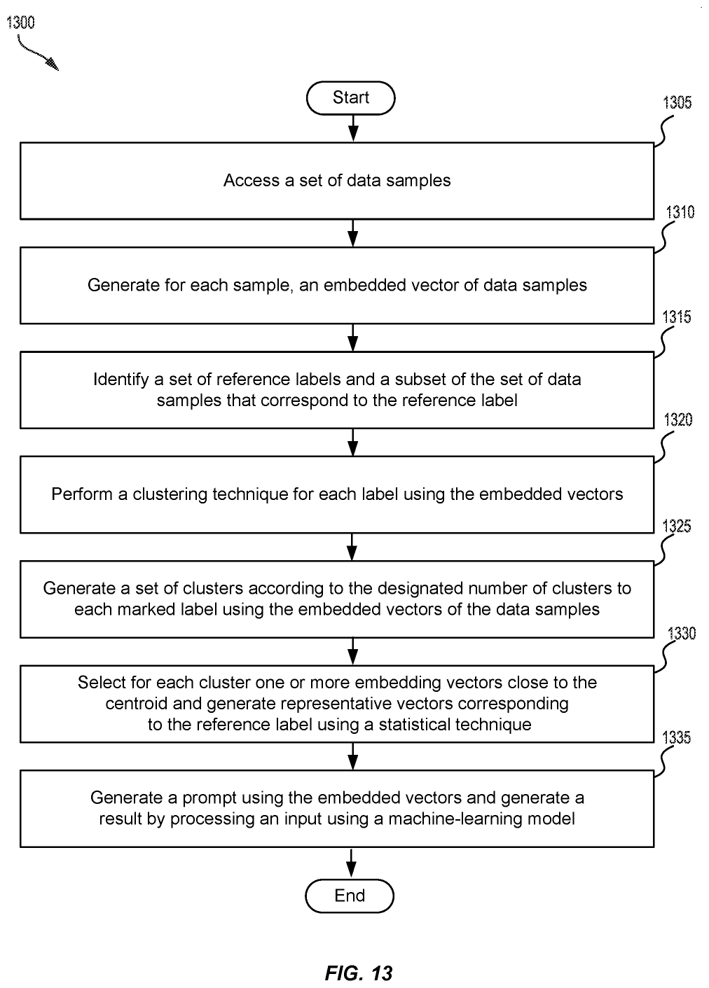

FIG. 13 illustrates an example flowchart of a computer-implemented method 1300 according to an example embodiment. Referring to FIG. 13, at block 1305, a set of data samples 105 is accessed. The set of data samples 105 is obtained from a set of imperfect labeled data. The data samples 105 may include text data, audio data, video data, time-series data and/or image data. At block 1310, for each sample in the set of data samples 105, an embedded vector of data samples 105 is generated. At block 1315, a set of reference labels is identified. For each data sample, a marked label is accessed, where the marked label belongs to the set of reference labels and for each reference label, a subset of the set of data samples 105 that correspond to the reference label is identified. At block 1320, a clustering 120 technique is performed using the embedded vectors of the data samples in the subset. The clustering 120 technique can be one of k-means clustering, adaptive k-means clustering, DBSCAN, or agglomerative clustering, hierarchical clustering, Gaussian mixture models etc. At block 1325, for each set of reference labels, one or more clusters are generated to each marked label of the set of reference labels, where the generation results in assigning the embedded vector of each of at least some data samples 105 in the subset to a cluster of the set of clusters. At block 1330, for each cluster of the set of clusters within a label, one or more embedded vectors close to the centroid are selected and data corresponding to the reference label is generated using a statistical technique and the selected one or more embedded vectors of the at least some of the set of clusters as being representative embedded vectors 140 of the cluster, wherein the statistical technique is configured such that a representation of or weight of selected one or more embedded vectors of each of the at least some of the set of clusters is the same. At block 1335, a prompt 180 is generated using, for each of the set of reference labels, the embedded vectors of at least some of the set of clusters and a result is generated by processing an input using a machine-learning model 155, wherein the input includes the prompt 180 and identifies another data sample, and wherein the result includes a prediction that or a probability of the other data sample corresponding to a given reference label of the set of reference labels.

Some embodiments of the present disclosure include a system including one or more data processors. In some embodiments, the system includes a non-transitory computer readable storage medium containing instruction which, when executed on the one or more data processors, cause the one or more data processors to perform part or all of one or more methods and/or part or all of one or more processes disclosed herein. Some embodiments of the present disclosure include a computer-program product tangibly embodied in a non-transitory machine-readable storage medium, including instructions configured to cause one or more data processors to perform part or all of one or more methods and/or part or all of one or more processes disclosed herein.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, although the present invention as claimed has been specifically disclosed by embodiments and optional features, modification and variation of the concepts herein disclosed may be resorted to by those skilled in the art, and that such modifications and variations are within the scope of this invention as defined by the appended claims.

The present description provides preferred exemplary embodiments only, and is not intended to limit the scope, applicability, or configuration of the disclosure. Rather, the present description of the preferred exemplary embodiments will provide those skilled in the art with an enabling description for implementing various embodiments. It is understood that various changes may be made in the function and arrangement of elements without departing from the spirit and scope as set forth in the appended claims.

Specific details are given in the present description to provide a thorough understanding of the embodiments. However, it will be understood that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail to avoid obscuring the embodiments.

1. A computer-implemented method comprising:
accessing a set of data samples;
generating, for each data sample of the set of data samples, an embedded vector of data samples;
identifying a set of reference labels;
accessing, for each data sample of the set of data samples, a marked label, wherein the marked label is one of the sets of reference labels;
for each of the set of reference labels:
identifying a subset of the set of data samples that correspond to the reference label using the marked labels of data samples in the set of data samples;
performing a clustering technique using the embedded vectors of the data samples in the subset;
generating a set of clusters using the embedded vectors of the data samples, wherein the generation results in assigning the embedded vector of each of at least some data samples in the subset to a cluster of the set of clusters;
selecting, for each cluster of the set of clusters, one or more embedded vectors; and
generating representative embedded vectors of the at least some of the set of clusters corresponding to the reference label using a statistical technique and the selected one or more embedded vectors, wherein the statistical technique is configured such that a representation of or weight of selected one or more embedded vectors of each of the at least some of the set of clusters is same;
generating a prompt using, for each of the set of reference labels, the embedded vectors of at least some of the set of clusters; and
generating a result by processing an input using a machine-learning model, wherein the input includes the prompt and identifies another data sample, and wherein the result includes a prediction that or a probability of the another data sample corresponding to a given reference label of the set of reference labels.

2. The computer-implemented method of claim 1, further comprising, for each of one or more reference labels of the set of reference labels:
selecting, for each cluster of the set of clusters, one or more embedded vectors close to associated centroid.

3. The computer-implemented method of claim 1, further comprising, for each of one or more reference labels of the set of reference labels:
availing, to a user and for each of the set of clusters, the data samples associated with the embedded vectors of the cluster;
receiving, for each cluster of at least one of the set of clusters, an indication that the data samples associated with the embedded vectors of the cluster do not correspond to the set of reference labels; and
generating data corresponding to the reference label using embedded vectors associated with clusters of the set of clusters but not using the selected one or more embedded vectors, wherein the prompt includes or is based on the data corresponding to the generated data.

4. The computer-implemented method of claim 1, further comprising, for each of one or more reference labels of the set of reference labels, determining a probability threshold, the method includes:
generating, for each embedded vector associated with the generated data, probabilities using a probabilistic model indicating a likelihood of association of each embedded vector from the generated data with a particular reference label;
generating, for each embedded vector associated with a nil data sample of a set of nil data samples, probabilities using the probabilistic model indicating the likelihood of association of each embedded vector from the set of nil data samples with the particular reference label, wherein a nil data sample do not correspond to the set of reference labels; and
selecting a maximum ratio as a probability threshold for the particular reference label by iteratively comparing the probabilities generated for the embedded vectors associated with the generated data and the probabilities generated for the embedded vectors associated with the nil data samples of the set of nil data samples.

5. The computer-implemented method of claim 1, further comprising:
identifying one or more entity names for querying;
detecting a webpage associated with an entity name of the one or more entity names, wherein the webpage is estimated to have been newly generated within a predefined absolute or relative time period and to be associated with one or specific entities; and
extracting a data sample from the webpage.

6. The computer-implemented method of claim 5, further comprising:
generating, using another machine-learning model, a predicted probability of one or more subsequent data samples associated with the entity name being associated with a particular reference label of the set of reference labels.

7. The computer-implemented method of claim 1, further comprising:
generating another result by processing the data sample using another machine-learning model, wherein the other result includes another prediction as to whether or another probability of the other text string corresponding to the given reference label; and
generating a blended result based on the result and the other result.

8. A system comprising:
one or more data processors; and
a non-transitory computer readable storage medium containing instructions which, when executed on the one or more data processors, cause the one or more data processors to perform operations including:
accessing a set of data samples;
generating, for each data sample of the set of data samples, an embedded vector of data samples;
identifying a set of reference labels;
accessing, for each data sample of the set of data samples, a marked label, wherein the marked label is one of the sets of reference labels;
for each of the set of reference labels:
identifying a subset of the set of data samples that correspond to the reference label using the marked labels of data samples in the set of data samples;
performing a clustering technique using the embedded vectors of the data samples in the subset;
generating a set of clusters using the embedded vectors of the data samples, wherein the generation results in assigning the embedded vector of each of at least some data samples in the subset to a cluster of the set of clusters;
selecting, for each cluster of the set of clusters, one or more embedded vectors; and
generating representative embedded vectors of the at least some of the set of clusters corresponding to the reference label using a statistical technique and the selected one or more embedded vectors, wherein the statistical technique is configured such that a representation of or weight of selected one or more embedded vectors of each of the at least some of the set of clusters is same;
generating a prompt using, for each of the set of reference labels, the embedded vectors of at least some of the set of clusters; and
generating a result by processing an input using a machine-learning model, wherein the input includes the prompt and identifies another data sample, and wherein the result includes a prediction that or a probability of the another data sample corresponding to a given reference label of the set of reference labels.

9. The system of claim 8, further comprising, for each of one or more reference labels of the set of reference labels:
selecting, for each cluster of the set of clusters, one or more embedded vectors close to associated centroid.

10. The system of claim 8, further comprising, for each of one or more reference labels of the set of reference labels:
availing, to a user and for each of the set of clusters, the data samples associated with the embedded vectors of the cluster;
receiving, for each cluster of at least one of the set of clusters, an indication that the data samples associated with the embedded vectors of the cluster do not correspond to the set of reference labels; and
generating data corresponding to the reference label using embedded vectors associated with clusters of the set of clusters but not using the selected one or more embedded vectors, wherein the prompt includes or is based on the data corresponding to the generated data.

11. The system of claim 8, further comprising, for each of one or more reference labels of the set of reference labels, determining a probability threshold, the operations include:
generating, for each embedded vector associated with the generated data, probabilities using a probabilistic model indicating a likelihood of association of each embedded vector from the generated data with a particular reference label;
generating, for each embedded vector associated with a nil data sample of a set of nil data samples, probabilities using the probabilistic model indicating the likelihood of association of each embedded vector from the set of nil data samples with the particular reference label, wherein a nil data sample do not correspond to the set of reference labels; and
selecting a maximum ratio as a probability threshold for the particular reference label by iteratively comparing the probabilities generated for the embedded vectors associated with the generated data and the probabilities generated for the embedded vectors associated with the nil data samples of the set of nil data samples.

12. The system of claim 8, further comprising:
identifying one or more entity names for querying;
detecting a webpage associated with an entity name of the one or more entity names, wherein the webpage is estimated to have been newly generated within a predefined absolute or relative period and to be associated with one or specific entities; and
extracting a data sample from the webpage.

13. The system of claim 12, further comprising:
generating, using another machine-learning model, a predicted probability of one or more subsequent data samples associated with the entity name being associated with a particular reference label of the set of reference labels.

14. The system of claim 8, further comprising:
generating another result by processing the other data sample using another machine-learning model, wherein the other result includes another prediction as to whether or another probability of the other text string corresponding to the given reference label; and
generating a blended result based on the result and the other result.

15. A computer-program product tangibly embodied in a non-transitory machine-readable storage medium, including instructions configured to cause one or more data processors to perform operations including:
accessing a set of data samples;
generating, for each data sample of the set of data samples, an embedded vector of data samples;
identifying a set of reference labels;
accessing, for each data sample of the set of data samples, a marked label, wherein the marked label is one of the sets of reference labels;
for each of the set of reference labels:
identifying a subset of the set of data samples that correspond to the reference label using the marked labels of data samples in the set of data samples;
performing a clustering technique using the embedded vectors of the data samples in the subset;
generating a set of clusters using the embedded vectors of the data samples, wherein the generation results in assigning the embedded vector of each of at least some data samples in the subset to a cluster of the set of clusters;
selecting, for each cluster of the set of clusters, one or more embedded vectors; and
generating representative embedded vectors of the at least some of the set of clusters corresponding to the reference label using a statistical technique and the selected one or more embedded vectors, wherein the statistical technique is configured such that a representation of or weight of selected one or more embedded vectors of each of the at least some of the set of clusters is same;
generating a prompt using, for each of the set of reference labels, the embedded vectors of at least some of the set of clusters; and
generating a result by processing an input using a machine-learning model, wherein the input includes the prompt and identifies another data sample, and wherein the result includes a prediction that or a probability of the data sample corresponding to a given reference label of the set of reference labels.

16. The computer-program product of claim 15, further comprising, for each of one or more reference labels of the set of reference labels:
availing, to a user and for each of the set of clusters, the data samples associated with the embedded vectors of the cluster;
receiving, for each cluster of at least one of the set of clusters, an indication that the data samples associated with the embedded vectors of the cluster do not correspond to the set of reference labels; and
generating data corresponding to the reference label using embedded vectors associated with clusters of the set of clusters but not using the selected one or more embedded vectors, wherein the prompt includes or is based on the data corresponding to the generated data.

17. The computer-program product of claim 15, further comprising, for each of one or more reference labels of the set of reference labels, determining a probability threshold, the operation includes:
generating, for each embedded vector associated with the generated data, probabilities using a probabilistic model indicating a likelihood of association of each embedded vector from the generated data with a particular reference label;
generating, for each embedded vector associated with a nil data sample of a set of nil data samples, probabilities using the probabilistic model indicating the likelihood of association of each embedded vector from the set of nil data samples with the particular reference label, wherein a nil data sample do not correspond to the set of reference labels; and
selecting a maximum ratio as a probability threshold for the particular reference label by iteratively comparing the probabilities generated for the embedded vectors associated with the generated data and the probabilities generated for the embedded vectors associated with the nil data samples of the set of nil data samples.

18. The computer-program product of claim 15, further comprising:
identifying one or more entity names for querying;
detecting a webpage associated with an entity name of the one or more entity names, wherein the webpage is estimated to have been newly generated within a predefined absolute or relative time period and to be associated with one or specific entities; and
extracting a data sample from the webpage.

19. The computer-program product of claim 18, further comprising:
generating, using another machine-learning model, a predicted probability of one or more subsequent data samples associated with the entity name being associated with a particular reference label of the set of reference labels.

20. The computer-program product of claim 15, further comprising:
generating another result by processing the data sample using another machine-learning model, wherein the other result includes another prediction as to whether or another probability of the other text string corresponding to the given reference label; and
generating a blended result based on the result and the other result.
